(19) United States
(12) Patent Application Publication
(10) Pub. No.: US 2007/0239490 A1
(43) Pub. Date: Oct. 11, 2007

(54) COMPUTERIZED RISK MANAGEMENT MODULE FOR MEDICAL DIAGNOSIS

(76) Inventor: Daniel Joseph Sullivan, Oak Brook Terrace, IL (US)

Correspondence Address: PATZIK, FRANK & SAMOTNY LTD., 150 SOUTH WACKER DRIVE, SUITE 1500, CHICAGO, IL, 60606, US

(21) Appl. No.: 11/691,486

(22) Filed: Mar. 26, 2007

Related U.S. Application Data
(63) Continuation-in-part of application No. 10/000,879, filed on Nov. 2, 2001, now Pat. No. 7,197,492.
(60) Provisional application No. 60/245,255, filed on Nov. 2, 2000.

(51) Int. Cl. G06F 17/30

(52) U.S. Cl. 705/3

(57) ABSTRACT

Apparatus and a method are provided for improving the medical care of patients. The apparatus includes an input device, a medical risk database, a data processor, and a communication device. Data entered in the input device, usually by a health care professional, defines a patient data record. The medical risk database associates certain patient data entered into the data record, which increases the risk of a missed medical care opportunity, with additional medical care to address the risk. The communication device responds to the identification of patient data presenting a medical risk by communicating to a health care professional additional medical care selected to identify and take advantage of a medical care opportunity.

This application is a continuation in part patent application of U.S. application Ser. No. 10/000,879, filed Nov. 2, 2001, which claims the benefit of U.S. Provisional Application No. 60/245,255, filed Nov. 2, 2000, the entirety of which are hereby incorporated by reference.

### FIELD OF THE INVENTION

This invention generally relates to apparatus and methods for improving medical care. (“Medical care” is broadly defined here to include both medical diagnosis and therapeutic treatment of a patient.) This invention relates more particularly to such apparatus and methods that can be used by a health care professional to avoid making the kinds of professional mistakes that can lead to a significant risk of medical errors, patient injury and legal liability.

### BACKGROUND OF THE INVENTION

“Healthcare professionals” or “healthcare provider” or “practitioner” or “caregiver” are terms used broadly here to refer to anyone who participates in the diagnosis or treatment of medical problems. For example, medical doctors, dentists, nurses, nurse-practitioners, medical technologists, physical therapists, and other health workers that assist in examination of patients, diagnosis, or treatment are all included by these terms.

A healthcare professional diagnoses an illness by collecting and evaluating information about the patient, then determining what disease or condition best fits the information. The information gathered from the patient usually is processed to reach a diagnosis by using a protocol learned during the professional's professional training and modified and updated by his or her medical experience. The protocol is an ordered process by which a healthcare professional ascertains information that allows the professional to rule out possible diseases until enough information is gathered to eliminate all but the diagnosed condition. Alternatively, the protocol may end when an appropriate treatment is identified. Recently, medical associations, health maintenance organizations, and hospitals, among others, have prescribed protocols. Employed healthcare professionals in particular are often subject to mandated protocols.

One problem in the field of medicine is how to improve diagnostic protocols to take into account advances in medical knowledge. A related problem is how to ensure that health care professionals update their skills to take advantage of advances in medical knowledge. Still another problem is how to expedite the diagnosis and treatment of certain conditions that should be treated quickly, so treatment can begin soon enough to be most effective.

U.S. Pat. No. 6,095,973 discloses a data processing system and method for evaluating the treatment of chest pain patients in a medical facility.

U.S. Pat. No. 6,029,138 discloses a decision support system for the selection of a diagnostic test or therapeutic intervention, which are both called “studies” in that patent.

U.S. Pat. No. 4,857,713 discloses a program for reducing hospital errors in the delivery of medications, goods, services or procedures in patient treatment.

U.S. Pat. No. 5,732,397 describes an automated system for use in decision-making processes, which is said to improve the quality and consistency of decisions made.

U.S. Pat. No. 5,772,585 discloses a common user interface to allow different medical personnel access to centralized files regarding patients.

U.S. Pat. No. 5,832,450 describes an electronic medical record system that stores data about individual patient encounters in a convenient form.

U.S. Pat. No. 5,845,255 describes an electronic prescription creation system for physician use that includes an adverse indication review and online access to comprehensive drug information including scientific literature.

U.S. Pat. No. 5,911,132 discloses diagnosing and treating patient diseases using a epidemiological database containing medical, personal or epidemiological data relevant to a presented set of symptoms, test results, a diagnosis, etc.

U.S. Pat. No. 5,915,240 discloses a context-sensitive medical lookup reference computer system for accessing medical information over a network.

U.S. Pat. No. 5,924,074 discloses a medical records system that is said to create and maintain all patient data electronically.

U.S. Pat. No. 5,953,704 discloses a system in which a user inputs information related to the health condition of an individual.

U.S. Pat. No. 6,022,315 discloses a system and method for providing computerized, knowledge-based medical diagnostic and treatment advice to the general public over a telephone network or a computer network.

There is currently a need in the medical field for a system that communicates to a healthcare professional carrying out a diagnosis that a certain symptom, combination of symptoms, or other patient information recorded by the physician is associated with an increased risk of a missed medical care opportunity leading to a less favorable patient outcome. (A “medical care opportunity” is defined as an opportunity to correctly or more quickly diagnose or treat the patient's condition and thus provide a better patient outcome.) Further, there is also a need in the medical field for a system for communicating to the health care professional special steps to take to avoid the missed medical care opportunity.

### BRIEF SUMMARY OF THE INVENTION

One aspect of the invention is an apparatus for improving the medical care of patients. The apparatus includes an input device, a medical risk database, a data processor, and a communication device.

The input device can be any device that is useful for entering medical data relating to a patient. Data entered in the input device defines a patient data record.

The medical risk database associates certain patient data, which increases the risk of a missed medical care opportunity, with additional medical care. The additional medical care is a predetermined action that reduces the risk of a missed medical care opportunity, despite the presentation of the patient data.

The data processor is programmed to compare the patient data record with the medical risk database. This comparison is carried out to identify patient data in the record that increases the risk of a missed medical care opportunity.

The communication device responds to the identification of patient data that increases the risk of a missed medical care opportunity. The communication device responds by communicating to a healthcare professional additional medical care. The additional medical care is selected to reduce the risk of a missed medical care opportunity.

Another aspect of the invention is an interactive method a healthcare professional can use for avoiding medical risk while the healthcare professional is providing medical care to a patient.

The healthcare professional records medical data presented by the patient in a data storage device, forming data records.

The healthcare professional has access to a medical risk database maintained on a data storage medium. The database associates certain medical data with additional medical care. The certain medical data is data that increases the risk of a missed medical care opportunity. The additional medical care is something that can be done to reduce the risk of a missed medical care opportunity, despite the presentation of the certain medical data.

A data processor is used to compare the medical data presented by the patient with the medical data in the medical risk database to identify whether medical data presented by the patient is associated with a risk of missed medical care opportunity.

If medical information presented by the patient is associated with a risk of missed medical care opportunity, information about additional medical care that would reduce the risk of a missed medical care opportunity is presented to the healthcare professional.

Another aspect of the invention is a red-light, green-light prompting system that suggests or prompts the healthcare provider to include the important or critical elements of documentation of a patient's particular medical condition in the medical record. This component of the invention contains some aspects of simple medical logic. For example, the critical elements of documentation for a patient with a laceration are not known until the specific location of the laceration is known. Once the health care provider indicates the location of the laceration, the red-light, green-light prompts then appear at the appropriate locations in the templated medical record. Prompting systems other than a red-light green-light system can be used.

Another aspect of the invention is immediate electronic access to critical information behind a “key information” icon, at various points throughout the many templates. For example in the shoulder injury template, in the physical exam section for the shoulder, there are three key information icons containing the following information: 1) the anatomy of the shoulder; 2) the vascular anatomy of the arm; and 3) the nerve distribution of the arm in a dermatome map. This information is currently available in textbooks, on the Internet, or in policy and protocols. The key information icons make this critical information immediately accessible as the healthcare provider evaluates the patient and/or creates the medical record.

Another aspect of the program is the use of the red-light green-light system, and a drop down list of acute life threatening emergencies, utilized by the triage nurse to identify, expedite and prioritize patients with these special conditions. Accordingly, in the triage situation, a warning about the high-risk diagnosis is indicated. This part of the invention also contains a special warning to notify the physician and charge nurse in the emergency department. This red-light green-light system also provides mandatory notification of the existence of a second-to-minutes type emergency to the attending physician or attending nurse. Other types of prompting or warning systems may be used.

The present invention includes a computerized medical chart system communicating with a healthcare professional comprising: input means such as a mouse, keyboard or touch screen panel for inputting information regarding a patient; data storage means such a disk drive or server operably connected to the input means such as a video display or monitor for receiving the patient information; a collection of medical risk, healthcare quality; and/or patient safety information; means for comparing being operably associated with the data storage means and having access to the collection of medical risk information for comparing the patient information to the medical risk, healthcare quality, and/or patient safety information; and, warning means operably associated with the comparing means for issuing a warning, treatment or patient management recommendation either visual, audible and/or otherwise likely to be noticed by the healthcare professional when certain conditions arise; or alerting the healthcare professional regarding treatment or management recommendations.

The system further includes: the patient information comprising the vital signs information of the patient; display means operably associated with the data storage means for displaying the vital signs information of the patient in graph form so as to show any trends in said vital signs over time; the collection of medical risk information including information regarding vital signs trends and normal ranges for such vital signs trends over time; and, the warning means issuing a warning when the vital signs trends are outside the normal range.

The system can further include: the patient information comprising the pulse rate and temperature information of the patient; the collection of medical risk information including information regarding normal ranges for such patient pulse rates, temperatures and the normal disparity between the two readings; and, the warning means issuing a warning when the disparity between pulse rate and temperature is outside the normal range.

In addition, the patient information and the medical risk information can further include blood pressure and respiratory rate information. The collection of medical risk information can also include information regarding possible critical events for the patient. The means for comparing can determine if there is a critical event occurring regarding the patient. The warning means issues a warning or prompt to the healthcare provider when a critical event with respect to the patient is occurring.

Likewise the collection of medical risk information includes information regarding possible “seconds to minutes” emergency situations that occur with respect to patients. The means for comparing can be a microprocessor or the like for determining if there is a “seconds to minutes” emergency occurring by comparing the patient information to the information contained or accessible to the risk database. A warning is issued when a “seconds to minutes” emergency is occurring.

The invention further includes the collection of medical risk information (i.e. risk database) including information regarding increased risk situations. The means for comparing determines if there is an increased risk situation. A risk alert is provided to the healthcare provider when an increased risk situation occurs and, information about the increased risk situation is provided to the healthcare provider.

Likewise, the system further includes the collection of medical risk information including information regarding evidence based treatment information. The comparing means determines if the evidence based treatment information is applicable to the patient and, means are provided to provide a treatment and/or management recommendation to the healthcare provider when the evidence based treatment information is applicable.

The invention further includes: the medical risk information including patient management information. A treatment recommendation provides a management recommendation to the healthcare provider when applicable.

The collection of medical risk information can further include information regarding patient attributes. The comparing means provides information choices to the healthcare provider based on the patient information and filters the information choices presented to the healthcare provider as dynamic content depending on the patient attributes.

A rules engine provides information regarding the patient to the healthcare provider in response to the presence of certain conditions based on the patient information. The information provided is a request for the input of additional patient information. The information provided could alternatively or in addition, be a recommendation to take action, if certain conditions are met by the patient information that has been provided.

The computerized medical chart system further includes the medical risk database further including information concerning patient safety and/or seeking to improve the quality of patient care.

The invention further includes including information regarding differential diagnosis information regarding certain symptoms in the risk database. The comparing means determines if the differential diagnosis information is applicable to the patient. Information is also provided interactively to the healthcare provider about the differential diagnosis in real time when the information is applicable.

The present invention further includes a method for alerting a healthcare professional to patient information comprising: inputting patient information into data storage means operably connected thereto; comparing such patient information to information contained in a collection of medical risk information, operably accessible thereto; and, warning the healthcare professional when certain conditions arise or alerting the healthcare practitioner and/or providing treatment or management recommendations.

The patient information comprises the vital signs information of a patient over time. The method further includes the step of displaying the vital signs of the patient in graph form on display means operably associated with the data storage means to show any trends therein. The medical risk information includes normal ranges for vital signs trends. The warning or prompt occurs when the vital signs trends are outside the normal ranges.

The method further includes the patient information comprising two or more of the following: the pulse rate; blood pressure; respiratory rate; and/or temperature information of the patient. The medical risk information comprises normal ranges for the disparity between such vital signs information for the patient. The warning occurs when the disparity between the patient pulse and temperature are outside the normal ranges.

The medical risk information can comprise critical events for the patient and the warning occurs when a critical event regarding the patient occurs. Similarly, the medical risk information comprises increased risk situations and the warning or prompt occurs when an increased risk situation occurs.

Likewise, the medical risk information comprises “possible seconds to minutes emergencies” that occur with patients. The warning then occurs when a “seconds to minutes” emergency situation exists with respect to the patient.

Similarly, the medical risk information can comprise evidence based treatment and management information The method then includes providing a treatment and management recommendation to the healthcare provider when evidence based treatment is applicable with respect to the patient.

In addition, the medical risk information can also comprise the particular attributes of the patient such as age, sex, chronic health conditions and attributes. Filtering the information choices provided to the healthcare provider based on the patient attributes and, providing information choices as dynamic content to the healthcare provider are also part of the invention. Providing information regarding the patient to the healthcare provider based on a rules engine is also part of the invention.

The method of the present invention further includes the medical risk information comprising differential diagnosis information regarding certain symptoms and, providing differential diagnosis information to the healthcare practitioner interactively in real time when applicable.

### BRIEF DESCRIPTION OF THE DRAWINGS

Other objects and advantages of the invention will become apparent upon reading the following detailed description and upon reference to the drawings in which:

FIG. 1 is a schematic view of one example of a medical charting system suitable for carrying out the present invention.

FIG. 2 shows a portion of an exemplary medical diagnostic template for use with the system of FIG. 1 when diagnosing chest pain.

FIG. 3 is similar to FIG. 2, but shows the template modified to display an activated medical risk icon when an entry is made on the template that the patient has chest pain radiating to the back.

FIG. 4 is a pop-up legend presented by the system when the activated medical risk icon is queried to determine the nature of the medical risk.

FIG. 5 is an illustration of a screen display of the chest pain electronic medical record template with the red-light, green-light prompts all red.

FIG. 6 is an illustration of a screen display of the chest pain electronic medical record template with the red-light, green-light prompts all turned green.

FIG. 7 is another illustration of a screen display of the chest pain electronic medical record template.

FIG. 8 is yet is another illustration of a screen display of the chest pain electronic medical record template showing the “cardiovascular” subsection.

FIG. 9 is yet another illustration of a screen display of the chest pain electronic medical record template wherein the user has selected “yes” to the query “Patient Over 40 Years of Age?”

FIG. 10 is yet is another illustration of a screen display of the chest pain electronic medical record template showing the “cardiovascular” subsection.

FIG. 11 is an illustration of a screen display demonstrating the use of the red-light, green light system to prompt the practitioner to consider the possible differential diagnosis and risk factors for a particular presentation. This figure shows three of the possible high-risk diagnoses in the chest pain patient on the “Risk Factor” line. These include 1) Coronary Artery Disease (CAD) 2) Thoracic Aortic Dissection (TAD) and 3) Pulmonary Embolism (PE).

FIG. 12 is an illustration of a screen display demonstrating that the practitioner has turned the red-lights green, thus having considered the differential diagnosis.

FIG. 13 is an illustration of a screen display of a template showing the key information icons.

FIG. 14 is an illustration of an information icon screen display.

FIG. 15 is an illustration of a screen display of an electronic medical record template showing the possible selections for the “high-risk” query.

FIG. 16 is an illustration of a screen display of an electronic medical record template showing a visual warning to the triage nurse or other user to contact an attending physician or charge nurse.

FIG. 17 is an illustration of a screen display of an electronic medical record template showing that the triage nurse has completed or “checked” a box associated with a statement indicating that the physician or charge nurse has been notified.

FIG. 18 is an illustration of a screen display of a patient reevaluation template.

FIG. 19 is another illustration of a screen display of a patient reevaluation template.

FIG. 20 is an illustration of a screen display of a vital sign template.

FIG. 21 is another illustration of a screen display of a vital sign template showing an example of a warning provided to a discharge nurse or physician during patient disposition.

FIG. 22 is an illustration of a screen display of a prescription medicine template.

FIG. 23 is another illustration of a screen display of a prescription medicine template.

FIG. 24 is an example of a flow chart diagram depicting the steps for generating vital sign trend graphs with associated alerts.

FIG. 25 is an example of a flow chart diagram showing steps for warning of pulse/temperature disparities.

FIG. 26 is an example of a flow chart diagram depicting steps for creating risk alerts.

FIG. 27 is an example of a flow chart diagram illustrating steps for generating risk alerts.

FIGS. 28 through 30 are examples of screen shots showing one embodiment for creating or displaying risk alerts.

FIG. 31 is an example of a flow chart diagram depicting steps for creating key information alerts.

FIG. 32 is an example of a flow chart diagram depicting steps for creating critical alerts.

FIG. 33 is an example of a flow chart diagram depicting steps related to the handling of critical orders and results.

FIGS. 34 through 36 are examples of screen shots showing one embodiment for handling critical orders and results.

FIG. 37 is an example of a flow chart diagram depicting steps for notifying of seconds to minutes emergencies.

FIGS. 38 and 39 are examples of screen shots showing one embodiment for handling seconds to minutes emergencies.

FIG. 40 is an example of a flow chart diagram depicting steps for providing conditional prompts.

FIG. 41 is an example of a flow chart diagram illustrating steps for providing dynamic content.

FIG. 42 is and example of a screen shot showing the results of dynamic content related to the age of patients suffering from chest pain.

FIG. 43 is an example of a flow chart diagram depicting steps for providing information on evidence-based medicine.

FIG. 44 is an example of a flow chart diagram illustrating steps related to a rules engine.

FIG. 45 is an example of a flow chart diagram illustrating steps pertaining to a process for interactive differential diagnosis.

### DETAILED DESCRIPTION OF THE INVENTION

While the invention will be described in connection with one or more embodiments, it will be understood that the invention is not limited to those embodiments. On the contrary, the invention includes all alternatives, modifications, and equivalents as may be included within the spirit and scope of the appended claims.

The present inventors have discovered a previously overlooked source of information from which appropriate diagnostic protocols can be developed: the results of medical malpractice claims. Each malpractice claim represents a decision made by a patient that his or her medical care was not appropriate and harmed him or her.

For example, a course prepared by inventor Daniel J. Sullivan, M.D., J.D., High-Risk Acute Care: The Failure to Diagnose (1998) identifies missed medical diagnoses as the principal cause of most malpractice suits. A missed medical diagnosis is defined here to include either the wrong diagnosis or a delayed diagnosis that leads to a materially worse patient outcome. This conclusion was reached by studying over 1000 medical malpractice suits to determine what caused the alleged malpractice and what could be done to avoid the alleged malpractice. High-Risk Acute Care: The Failure to Diagnose (1998) is incorporated herein by reference.

Data about medical malpractice claims has limited scientific value because the data is strongly influenced by non-medical factors. These factors include the differences among the jurors and judges involved in different cases, how credible, worthy, or attractive the plaintiff, the physician, and other parties and witnesses may appear to be, and the skill of the respective lawyers. Other factors include differences in the laws of different states and the common unavailability of data for many claims, particularly claims that are resolved by private settlement instead of by public judgment.

The outcome of cases that proceed to trial depends on whether jurors agree that the care given to the plaintiff that led to the filing of the lawsuit was appropriate.

The amount of damage awarded to a successful plaintiff reflects the jury's impression of how much worse the patient outcome was economically, compared to what it should have been. By putting a dollar value on the harm suffered by the plaintiff, a jury verdict reflects how much importance should be attached to the alleged error in patient care. Again, the medical or scientific communities do not commonly gather this information. It can only be obtained from litigation results.

Despite its limited scientific value, information obtained by studying medical malpractice claims is vitally important to improve diagnostic protocols. Medical malpractice claim experience largely reflects the attitudes of nonscientific, untrained, ordinary people. Such people have no connection with the scientific or medical worlds. The information they provide is not reflected in the usual diagnostic protocols, but often should be.

The present invention is not limited to information derived from medical malpractice claims. Any source of the required information, such as clinical experience, adverse outcomes, medical errors, scientific experimentation, or the opinions of expert health care professionals is contemplated to be useful here.

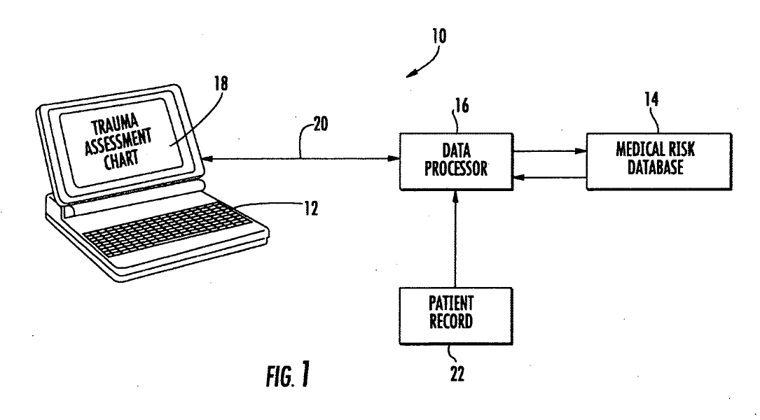

One embodiment of the invention is the medical charting system 10 shown in FIG. 1. The system 10 generally includes an input device 12, a medical risk database 14, a data processor 16, a communication device 18, and a data link 20.

The input device 12 can be any device that is useful for entering medical data presented by a patient. Data entered in the input device defines a patient data record.

One suitable input device is a cursor-moving device. A cursor moving device can be a pointing device such as a mouse, a track ball, a touch pad, a joystick, a voice-activated cursor directing program, a touch screen that moves a cursor responsive to finger or stylus placement or movement on the screen, etc.

Another suitable input device is a text entry device. A text entry device can be a keyboard for directly entering alphanumeric characters or other information directly. A non-alphanumeric keyboard can also be used, for example, a keyboard that has programmed keys directly representing the answers to medical questions indicative of medical information. A text entry device can be a text-generating device that converts spoken or handwritten words or characters into text entries. Two examples of text generating devices are a dictation program and the stylus and tablet of a personal digital assistant. Another suitable text entry device is a scanner for reading or copying alphanumeric text, a bar code, or other indicia.

Another type of input device contemplated here is a mechanism for transmitting data to the system 10 from a medical instrument. Examples of suitable medical instruments are an electrocardiograph, an electroencephalogram (EEG), a blood pressure measuring instrument, a pulse monitor, a thermometer, a laboratory machine, an intravenous drug administration monitor, or any others.

Yet another type of input device contemplated here is a communication device allowing a patient to enter data on his or her own patient record. It is advisable to identify the information so entered as coming from the patient, and to limit access of the patient so only appropriate portions of the patient record, such as the portion input by the patient, can be accessed by the patient, and so pertinent information cannot be erased or changed by the patient after it is entered.

Even another type of input device contemplated here is a magnetic strip reader for extracting information from a card carried by the patient, such as medical information that could be recorded on a patient-carried emergency medical information card or insurance card.

Still another type of input device contemplated here is a communication link between preexisting patient records and the medical charting system 10, as for communicating medical history or previous medical treatment information.

Yet another type of input device contemplated is a communication device adapted to allow for entry of patient information by the attending physician or other medical personnel from the patient's bedside. Such a communication device could be a hand-held computer or the like. It is also contemplated that patient information could be input vocally into the system 10 through a sound input device, such as a microphone or the like, by the attending physician or other medical personnel. Such an embodiment would eliminate the need to input the patient data into the system 10, thereby permitting the physician to treat the patient and input the patient data simultaneously.

The input device is used to input information about a patient. The information is stored as a patient data record 22. Examples are given below of patient record data that is pertinent to determining medical risks.

The patient data record 22 is physically embodied as data stored in any suitable medium. Suitable media include a hard drive, a floppy drive, a tape drive, a magnetic strip (as is often found on a credit card), or any other magnetic medium. Other suitable media include a CD, the internal memory of a computer, information written on paper or in microfiche form (either readable by a computer or by a physician), or in any other form, without limitation. The data in the patient data record 22 can be digital or analog data in text, numerical, graphic, audible, or any other form perceivable by a health care professional.

The patient data record 22 can be physically stored anywhere. For example, the patient data record 22 can be located in a drive of a portable computer, such as a notebook computer or a personal digital assistant, also providing the input device 12, data processor 16, and communication device 18 for the system. This could be a self-contained system carried by a health care professional and used for medical charting. Alternatively, the patient data record 22 can reside in a remote drive, computer, or server, as shown in FIG. 1, and be accessed via a data link 20.

The medical risk database 14 associates certain patient data, which increases the risk of a missed medical care opportunity, with additional medical care. The additional medical care is predetermined action that reduces the risk. Examples of the information in the medical risk database 14 are provided below.

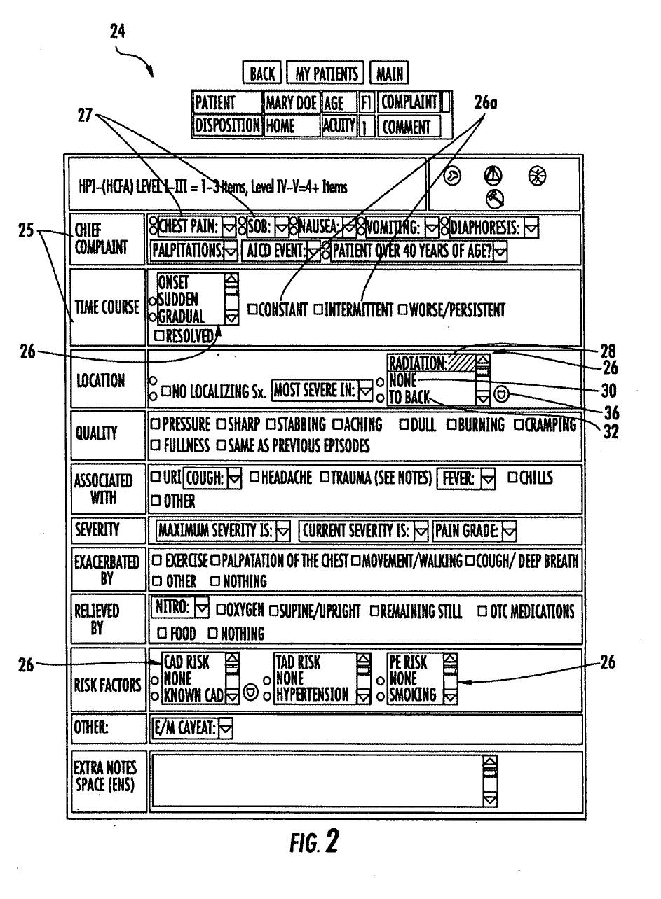

The medical risk database 14 is physically embodied as data stored in any suitable medium. Suitable magnetic media include a hard drive, a floppy drive, a tape drive, a magnetic strip such as the type often found on a credit card, or any other magnetic medium. Other suitable media include a CD, the internal memory of a computer, information recorded in paper or microfiche form (either readable by a computer or by a physician), or in any other form. The data in the medical risk database 14 can be digital or analog data in text, numerical, graphic, audible, or other perceivable form. The media in which the medical risk database and patient data record can be stored can be the same medium or different media. Either of them can be stored in more than one place or in more than one medium. In a simple embodiment, the database 14 can be built into the template 24 shown in FIG. 2 below, so entering certain patient data can prompt the presentation of a message that certain medical action is recommended.

The medical risk database 14 can be physically located anywhere. For example, the medical risk database 14 can be located in a drive of a notebook computer or personal digital assistant also providing the input device 12, data processor 16, and communication device 18 for the system. Alternatively, the medical risk database 14 can reside in a remote drive or computer, as shown in FIG. 1, and be accessed via a data link 20. It likewise can be either network based or Internet based.

The medical risk database 14 can be updated to reflect recent medical or legal experience. The updated database can be updated by providing a subscription CD or Internet download service, by updating a central database that is accessed by many health care professionals, or by any other effective method.

The data processor 16 is programmed to compare the patient data record 22 with the medical risk database 14. This comparison is carried out to identify patient data in the record 22 that increases the risk of a missed medical care opportunity. The data processor 16 can have any suitable form or configuration. It can be a dedicated microprocessor, a programmed general-purpose computer, or any other mechanical or electronic processing device. In a simple form of the system, the data processor can be used simply to update the display to present a communication, responsive to the entry of certain patient data.

The communication device 18 is any type of device that communicates to a health care professional the presence of an increased medical risk, based on the identification by the data processor of information in the patient data record 22 that increases the risk of a missed medical care opportunity. The system 10 responds by communicating to a health care professional proposed additional medical care. The additional medical care is selected to reduce the risk of a missed medical care opportunity.

One suitable embodiment of the communication device 18, illustrated in FIG. 1, is a video display operatively connected to the data processor 16 to visually communicate to the health care professional the presence of an increased medical risk. Another suitable embodiment of the communication device 18 is an alarm providing a signal perceptible to a health care professional. The alarm can be a visible warning, like a symbol on a graphical display or a warning light. The alarm can be an audible warning. The alarm can be a tactile warning, such as a signal sent to a vibrating pager, cellular telephone, or personal digital assistant worn or carried by the health care professional. The alarm can also be presented remotely, as to another health care professional that can attend to the alarm condition. In various embodiments, the alarm can be presented locally only, remotely only, or both locally and remotely.

The alarm can be arranged to ordinarily be selectively perceptible to a health care professional, and not to the patient. For example, it can be presented as a visual display on a terminal screen that is selectively viewable from one angle, presented toward the health care professional, and not from another angle where the patient's eyes are positioned.

The alarm can be encoded, to avoid alarming a patient who happens to encounter it. For example, it can be presented as a non-threatening icon on a visual display or a non-threatening sound. For another example, it can be made to appear or sound like something ordinary in the medical environment, such as an innocuous page on a public address system that is known only to the health care professional to relate to patient data being entered.

The data link 20 can be any means of communication of voice, data, or visual information now known or developed in the future. For example, the link 20 can be a telephone line, an Internet communication pathway (such as a telephone modem link, a dedicated link, a cable modem link, or a satellite link), computer wiring in a hospital or medical office, or any other communication path.

Another aspect of the invention is an interactive method a health care professional can use for avoiding medical risk while the health care professional is providing medical care to a patient. First, the health care professional records medical data presented by the patient in a data storage device, forming a patient data record 22. The health care professional has access to a medical risk database 14 maintained on a data storage medium. The database 14 associates certain medical data in the patient data record 22 with additional medical care. The health care professional uses a data processor 16 to compare the medical data presented by the patient data record 22 with the medical data in the medical risk database 14 to identify whether medical data presented by the patient is associated with a risk of missed medical care opportunity. If so, information about additional medical care that would reduce the risk of a missed medical care opportunity is presented to the attending medical health care professional.

Examples of Associations in the Medical Risk Database

Examples 1-5 presented in tables at the end of this specification are examples of associations between patient data, increased medical risk, and one or more proposed medical responses that can optionally be made by the medical risk database 14. Two examples of proposed medical responses are diagnostic steps, as shown in several of the examples, or treatment steps, shown for example in the Neck Pain table of Example 2.

The associations presented here are merely exemplary. A skilled health care professional who is familiar with the present disclosure and investigates medical liability results can readily find additional or alternative associations of the same type, useful for addressing the same or other medical conditions. Medical risk information is available from Daniel J. Sullivan, M.D., J.D., High-Risk Acute Care: The Failure to Diagnose (1998). This publication is incorporated by reference. A medical risk database incorporated in the PulseCheck® medical charting system is commercially available from IBEX Systems Group, Ltd. sometimes known as IBEX Healthdata Systems, 5600 N. River Road, Suite 150, Rosemont, Ill. 60018. The templates and medical risk data of the PulseCheck® medical charting system are incorporated by reference here. Other templates, medical risk data and medical charting systems can be used.

No representation is made that a health care professional should always follow the proposed advice, since it is not wise to rely solely on a preprogrammed database, unassisted by the judgment of a health care professional. The purpose of the medical risk database is simply to provide timely information to the health care professional that identifies and addresses a risk as it is presented.

Communication of Medical Risk

FIG. 2 shows a portion of an exemplary diagnostic template 24 that can be displayed on the communication device 18 when diagnosing a patient who complains of chest pain. This template 24, as with each template, includes a plurality of template sections. Each subsection 25 includes a plurality of queries 26, each relating to an observable patient medical condition (i.e.: whether the patient is vomiting, is nauseated, has chest pain). A query could be presented in the form of a checkable box (as with the query indicated as reference numeral 26a). Each query 26 includes a query heading 27 which identifies the patient medical condition for which the user is to input information. In the preferred embodiment, each query 26 includes a plurality of pre-selected observations (noted below) that the user can select. Each subsection also includes a plurality of qualifying statements, indicated generally as 26a, each having a checkable box. These qualifying statements can be selected by the user to narrow or further describe the information input by the user into the relevant query 26.

The template 24 as shown in FIG. 2 is in its initial condition, before a health care professional begins to respond to questions raised by the template or before the health care professional begins to input information into the queries 26. For example, the template 24 includes a query 26 to determine whether the chest pain is radiating toward the back. If not, “none” is marked by placing the cursor 28 on the “none” legend 30 for that answer and activating the choice (as by clicking a mouse button, if the cursor is moved by a mouse). The communication device 18 then displays that answer and the user is free to move on to other questions.

If the health care professional determines that the patient has chest pain radiating toward the back, “yes” is marked by placing the cursor 28 on the “to back” legend 32 for that answer and activating the choice. Other choices not shown in FIG. 2 are accessed by operating a scrolling button 34. Responsive to that answer, an icon 36 indicative of an increased medical risk is presented on the communication device 18.

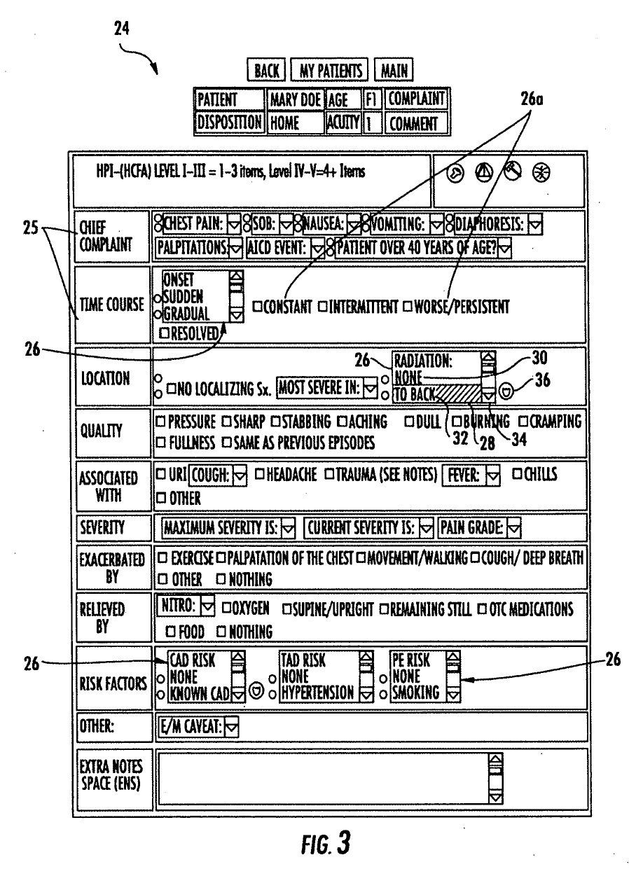

This icon 36 is displayed in FIG. 3, and is a fire-shaped, brightly colored icon that contrasts by its larger size and brighter red and orange colors with other indicia on the template 24. The icon 36 is also visible in FIG. 2, but is muted in color in FIG. 2 because it is not activated. The icon 36 is present in muted form before it is activated so a health care professional will not overlook the inquiry that activates the icon 36 when necessary.

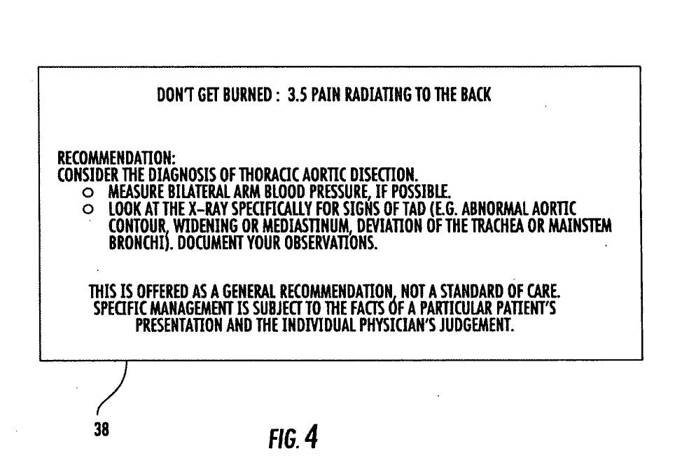

Upon activation of the icon 36, the health care professional can click on or otherwise query the icon 36. This might be done to find out what medical risk is presented or what additional medical care is necessary to reduce the medical risk resulting when the chest pain presented by the patient is radiating toward the back. This query causes an additional care legend or message to be presented on the communication device 18, such as the pop-up legend 38 shown as FIG. 4: “Recommendation: Consider the diagnosis of Thoracic Aortic Dissection (TAD). Measure bilateral arm blood pressure, if possible. Look at the X-ray specifically for signs of TAD (e.g. abnormal aortic contour, widening of mediastinum, deviation of the trachea or mainstem bronchi). Document your observations.” Thus, additional diagnostic steps are recommended to evaluate whether a TAD is present. The health care professional also is strongly encouraged to document his observations so the fact that the possibility of a TAD was thoroughly and quickly evaluated can be verified.

The medical risk raised by the symptom of chest pain radiating toward the back is that a TAD will be missed, as this is a condition that sometimes is not found quickly enough when a chest pain complaint is evaluated. This fact was ascertained by reviewing the scientific medical literature and the results of malpractice actions in which liability was found because a TAD allegedly should have been diagnosed soon enough to avoid further complications, but was not.

This medical risk has two components. One component is that a health care professional must recognize the possibility of a TAD very rapidly to reach the best possible patient outcome.

The other component is that, even if the health care professional quickly recognizes and properly evaluates the possibility of a TAD, but rules it out as inconsistent with other diagnostic indications, the pertinent facts must be documented in the patient's chart immediately. Even if the patient's condition has been properly evaluated as ruling out a TAD, an anomalous TAD could exist that would not have been recognized by even a skilled physician. Alternatively, the patient might not be suffering from a TAD initially, but may develop this condition shortly after the diagnosis that no TAD is present. If the symptoms presented by the patient at the time of diagnosis are properly and quickly evaluated and documented, the best possible care has been given, and the health care professional will be able to show this fact by reference to the patient's chart.

The present invention addresses the need to quickly evaluate and document TAD in a patient presenting chest pain that radiates to the back. The template 24 responds to the selection of this characterization of the chest pain immediately by presenting a distinctive and unusual warning, here the fire icon 36, that additional diagnostic work is necessary to rule out an increased medical risk of a TAD in this instance. This information is presented only when it is needed, so if this condition is not presented there is no need to alarm or distract the medical health professional by presenting this information.

The present invention works equally well to signal the need for additional care, whether diagnostic or therapeutic, when other conditions posing an increased medical risk are presented.

Red-Light Green-Light Prompting

Insurance company data and the scientific medical literature clearly indicate that poor medical record documentation, inadequate history taking and inadequate physical examinations are among the leading causes of medical errors, patient injuries and medical malpractice lawsuits. This part of the invention is designed to prompt health care practitioners to address factors in the history and physical examination that are critical to documenting a complete medical record, identifying important factors in the patient's history and physical examination, reduction in medical errors and resulting medical malpractice lawsuits.

The factors deemed critical to medical record documentation have been identified through an investigation by Daniel J. Sullivan, M.D., J.D., FACEP, into the scientific medical literature (multiple publications in the ED Legal Letter), and an analysis of over 100 malpractice lawsuits published in Dr. Sullivan's High Risk Acute Care: The Failure to Diagnose, noted herein above.

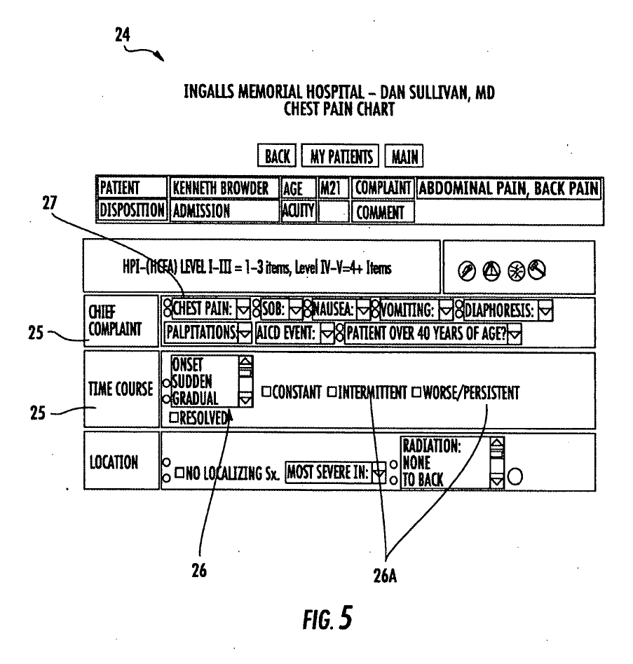

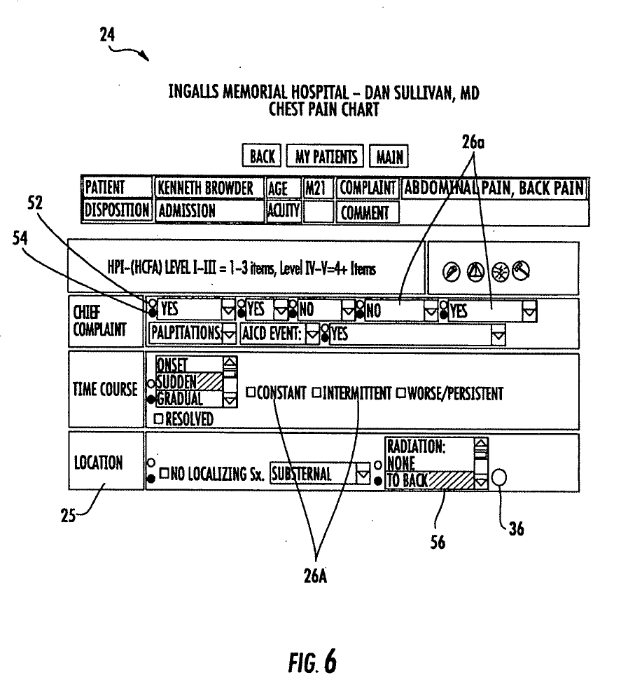

As noted above and as shown in FIGS. 2, 3, 5 and 6, each template 24 includes a plurality of queries 26. Each query 26 includes a red light prompt 52 and a green light prompt 54. The program displays or highlights the red light prompt 52 (as shown in FIG. 2) when the user has entered no input into the query 26. However, then the user inputs information into the query 26, the program displays or highlights the green light prompt 54. The prompts 52, 54 provide a visual display indicating to the user whether information has been observed or collected and input in the system 10. The red light prompts 54 and the green light prompts 52 form a red-light, green-light system. Other types of prompts are possible.

The red-light, green-light system are merely prompts, they are not mandatory. However, use of these prompts in a research setting, has led to an unprecedented level of documentation as demonstrated through the published, juried, scientific publication of Supplement to Annals of Emergency Medicine, October 2000 Volume 36 Number 4, Abstract # 110 entitled “On-Line Risk Management Combined With Template-Based Charting Improves the Documentation of Key Historical Data in Patients Presenting With Chest Pain”.

In addition, the use of the electronic template format allows the application of medical logic. It is impossible to know what factors in the history and physical examination are essential in patient care without some initial input from the practitioner. Once the practitioner begins entering information, the system 10 responds by allowing previously invisible red-lights, green lights to become visible.

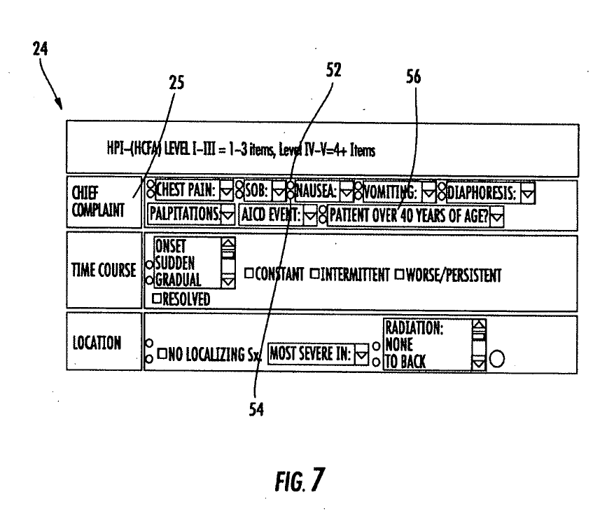

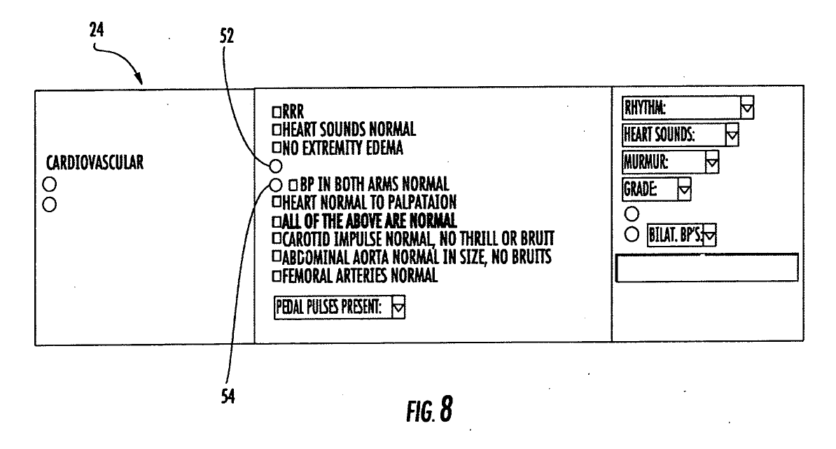

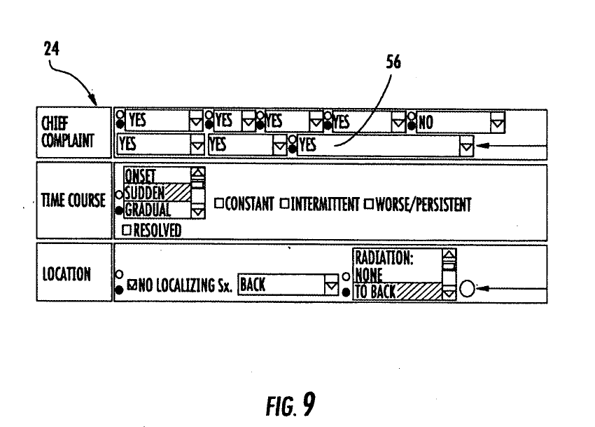

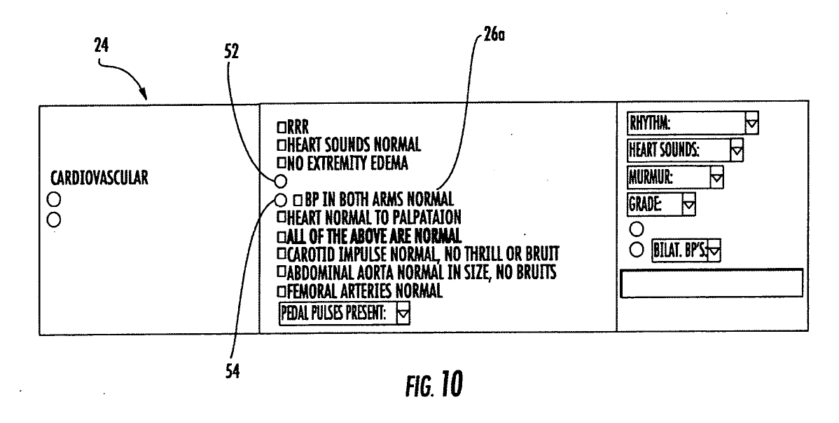

FIG. 7 is an example of an uncompleted chest pain template 24. Note the field generally designated as reference number 56 which posses the following question to the medical care provider in the “complaint” subsection 25: “Patient over 40 years of age?” Patient's over 40 years of age complaining of chest pain often suffer from Thoracic Aortic Dissection, which can be detected by measuring the blood pressure in both of the patient's arms. FIG. 8 is an illustration of an uncompleted “cardiovascular” subsection 25. Note the lack of red-light, green-light prompts 52, 54 associated with the checkable box query 26a which states, “BP in both arms normal”. FIG. 9 is an illustration of a chest pain template where the “complaint” subsection 25 has been completed. Note that the medical care provider has indicted that the patient is over 40 years of age in the field generally designated as reference number 56. In response thereto and as shown in FIG. 10, the system 10 has displayed a set of red-light, green-light prompts 52, 54 proximal to the checkable box query 26a which states, “BP in both arms normal”. Thus, the practitioner measures the patient's bilateral blood pressures, documents the result, specifically looking for and documenting the examination for a Thoracic Aortic Dissection.

The red-light, green light prompts 52, 54 also assist the practitioner in considering the differential diagnosis. In the typical patient medical presentation, the patient first states a problem. Based upon this problem, or chief complaint, the practitioner then considers a list of possible diagnoses, called the differential diagnosis. This list of possible diagnoses guides the practitioner as to what questions to ask, what organ systems to evaluate, and which diagnostic tests to order. The prompts 52, 54 assist the practitioner in considering the diagnoses, which are prone to being missed, or a particularly high-risk to the patient (i.e.: family history of certain illnesses, hypertension, etc.). The differential diagnosis each have a drop down list of risk factors 62, allowing the physician a method for immediate recall of difficult to remember historical items.

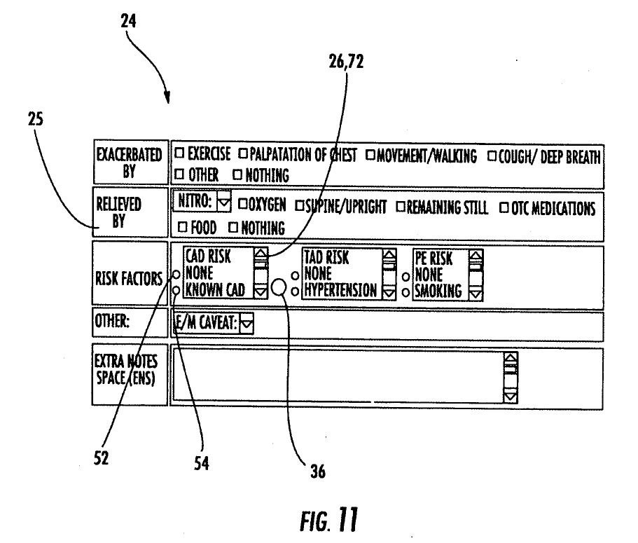

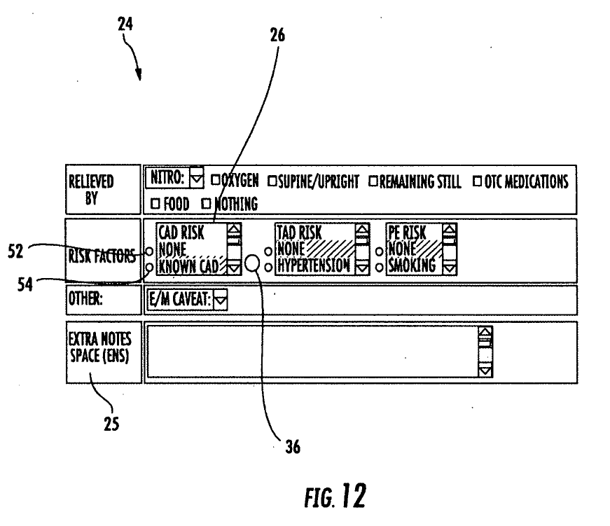

This function is demonstrated in FIGS. 11 and 12. FIG. 11 is an illustration of the risk factor section 25 of a template 24 as it would appear prior to entry of information in the queries 26. As shown in FIG. 12, upon selection of a risk factor in the first query, indicated as reference numeral 72, the system 10 highlights that query's green light prompt 54, and displays the fire icon 36 indicating to the user that a missed care opportunity may be present. Upon selection of the icon 36 by the user, a pop-up legend 38 (as illustrated in FIG. 4) appears indicating other observations, which should be performed by the health care provider. As noted above, the recommended observations are derived from prior occasions where a health care provider made an incorrect diagnosis because of the lack of additional observations by the health care provider.

Key Information Icons

Medical Practice is complex. Practitioners must remember or refer to a reference for a wide range of information. In actual practice, it is not possible to remember for an entire career, long lists of nerves with their specific function, long lists of tendons and how to test them, trauma scoring, croup scoring, Apgar scoring for the newborn, new standards of care and too many other lists, scores and other items to mention.

The simple fact is that practitioners need immediate reference to large amounts of diverse information that is often not immediately available in text, or on line. In addition, the busy practitioner seldom has time for looking up reference information.

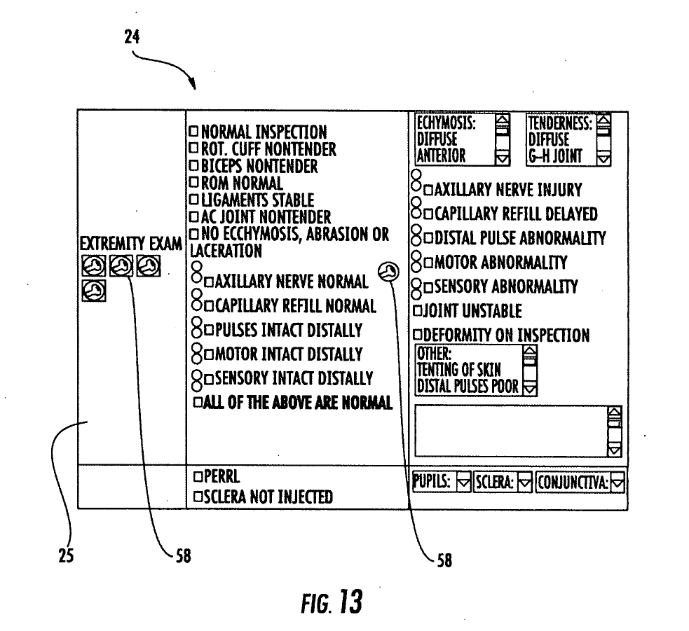

As shown in FIG. 13, based upon research and practice, the program provides immediate access via key information icons 58 to lists of critical information, anatomical drawings, scores of various kinds, updates on standards of care, tendon identification and testing. This information may be stored within the system 10, or may be accessed via the Internet or a Local Access Network (LAN) or the like. Further, this information may be graphical or textual.

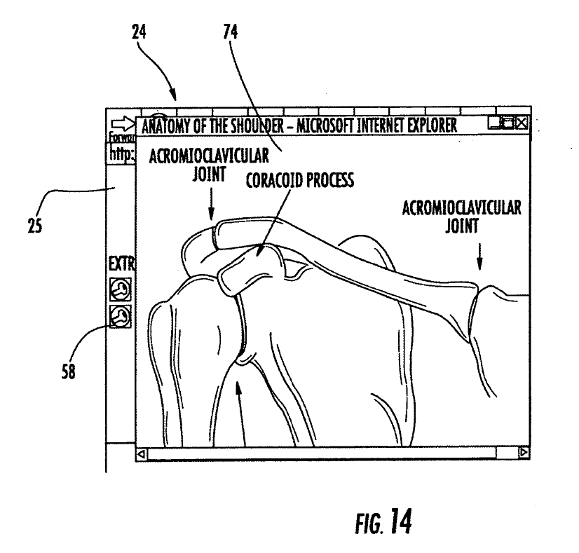

FIG. 13 is a screen display illustrating a subsection 25 of the shoulder injury. There are four key information icons 58 in the gray area labeled “extremity exam”. The practitioner can place a cursor or touch mechanism over the labeled icons 58 and with a single click, the program will provide an information icon screen display 74 which demonstrates the anatomy of the shoulder (see FIG. 14). Thus, the practitioner has immediate access to information, which simply may not be available in many medical settings.

Immediate Identification of High Risk Diagnoses

When patients present to an emergency department with a medical problem, in most cases, they first see a nurse in an area outside of the department, called triage. Triage is the sorting of patients by severity of illness. There are several illnesses that are so acute, that intervention must be immediate or the patient may suffer severe injury. The group of diagnoses includes such things as the following: chest pain in a patient over 35 years of age; a patient presenting a cold pulse-less extremity; a child under 2 months of age with a fever, etc.

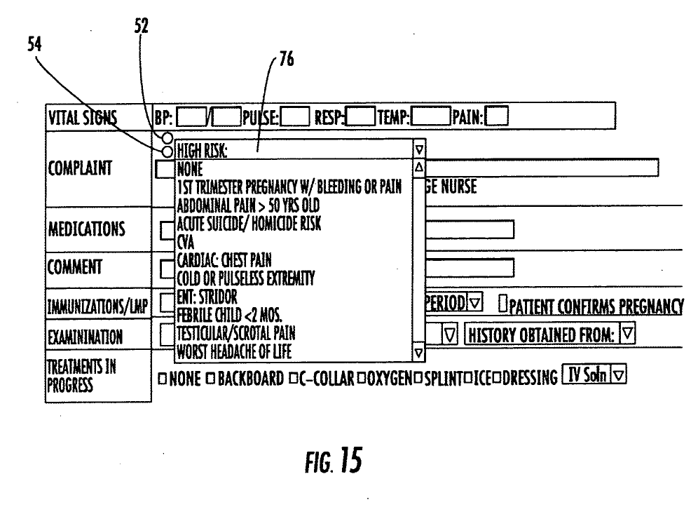

It is critical that the staff in triage recognize this small group of acute emergencies and communicates this to the appropriate individuals, such as the physician on duty in the emergency department or the charge nurse. As shown in FIG. 15, this invention provides the triage nurse with an electronic template, which includes a drop down list of these high-risk acute presentations 76. That part of the template contains a red-light, green-light prompt 52, 54, and in order to obtain a high level of compliance with the use of this function, the triage nurse must, at a minimum, select “none”.

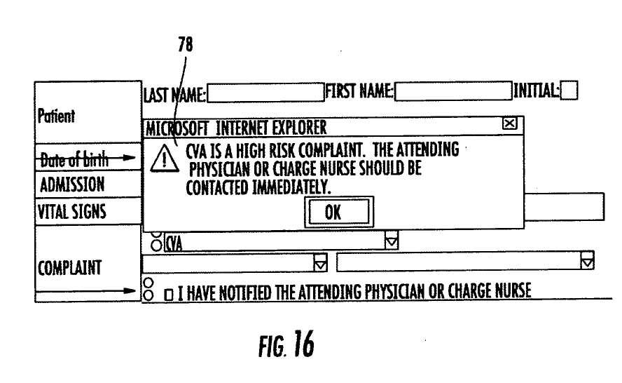

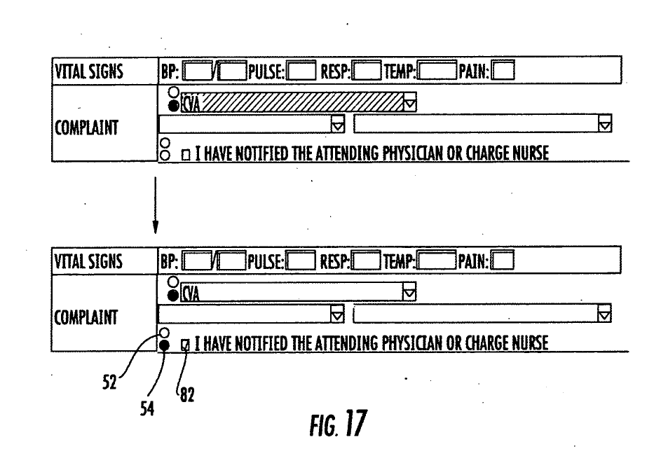

As shown in FIG. 16, if the nurse chooses one of these high-risk diagnoses, the program immediately pops up a warning 78 indicating that immediate notification of the physician or charge nurse must occur. Referring to FIG. 17, once the physician or charge nurse has been notified, then the triage nurse completes or “checks” a box 82 associated with a statement indicating that the physician or charge nurse has been notified. A red-light, green-light prompt 52, 54 associated with this statement then notes that this task has been completed. In this fashion, the combination of the red-light, green-light prompt 52, 54 and the high-risk list 76 assists the triage nurse in quickly identifying the acute emergencies, making the patient a high priority for treatment in the emergency department, and in recording the interactions between the triage nurse and the physician or charge nurse. Other types of prompts can be used.

Nursing Re-Evaluation of Patient Condition

Consistent and timely reevaluation of a patient's medical condition while the patient is in the waiting room, in the emergency department or the like, waiting for test results, a transfer or the like is critical to ensure discovery of changes in the patient's condition. An undetected change in a patient's medical condition increases the risk of a missed medical care opportunity. Therefore, to ensure consistent and timely reevaluation of a patient's medical condition, especially in chaotic environments such as a hospital emergency room and the like, the present system 10 includes a patient reevaluation template 84 which provides medical personnel with timed reminders of when to perform a reevaluation.

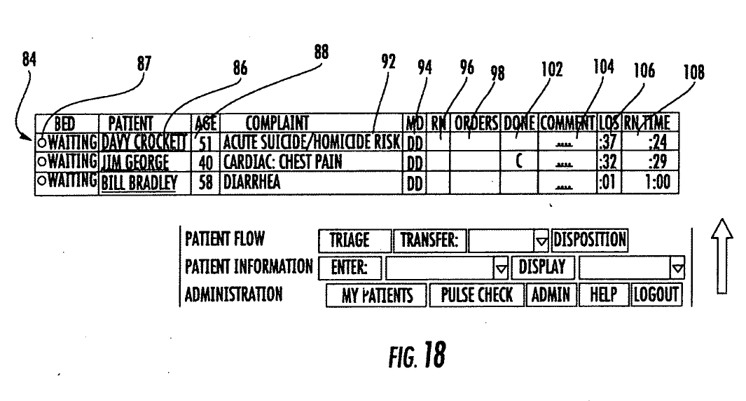

Referring to FIG. 18, the patient reevaluation template 84 is provided having a “patient” name field 86 which, when selected, displays a list of templates 24 (not shown) created for the patient, a “bed” field 87 for indicating whether the patient is waiting for a bed or for indicating the bed or stretcher location, an “age” field 88 for displaying the patient's age, a “complaint” field 92 for displaying the patient's chief complaint, an “MD” field 94 for displaying the initials of the patient's treating physician, an “RN” field 96 for displaying the initials of the nurse charged with the patient's care, an “order” field 98 for a listing of any pending orders ordered by the treating physician (i.e. lab tests, CAT scans and the like), a “done” field 102 which provides the nurse or physician a visual indicator of the status of a patient (i.e. the “done” field displays a “C” after a chart template has been completed for a patient, an “X” after a patient has been X-rayed, and displays a green color when all treatment has been completed), a “comment” field 104 for listing and/or entering general information about the patient, a length-of-stay or “LOS” field 106 for indicating the length of time for which the patient has been present in a particular department (i.e. the emergency room), and an “RN time” indicator 108. The RN time indicator 108 counts down from a pre-set specified time period. In one embodiment, the RN time indicator 108 provides a visual and/or audible warning that a predetermined amount of time remains before reevaluation is due. For example, the RN time indicator 108 may change colors so that the field turns yellow when 25% of the total time remains, and turns red when 10% of the time remains.

With the knowledge provided by the RN time indicator 108, the RN reevaluates the patient before time elapses, consistent with department policy and good patient care. Any documented reevaluation (i.e. by obtaining vital signs or entering an assessment note) resets the RN time indicator 108 to the specified time period.

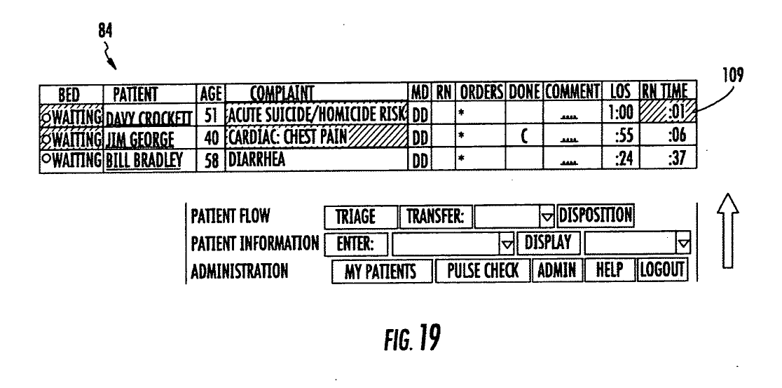

In the preferred embodiment, if the health care provider fails to reevaluate the patient within the specified time period, the RN time indicator 108 provides a visual and/or audible warning that reevaluation is required. Further, the RN time indicator 108 counts forward from the expired time period to give an indication how far the health care provider has allowed the reevaluation period to extend. For example, in the template 84 illustrated in FIG. 19, the RN time indicator indicated by reference number 109 for the patient named “Davy Crockett” indicates that the pre-set time period has expired, and that reevaluation is one minute overdue.

The system 10 records all patient reevaluations. Specifically, the system 10 records each time the RN time indicator 108 is reset, the time period between each reevaluations, and who performed the reevaluation. The system 10 then later generates a report based on this recorded information that can later be used for assessments, teaching, litigation, etc. For example, the report can be used to access whether a nurse or physician is consistently performing reevaluations beyond the allotted time period.

Vital Sign Alerts

A patient's “vital signs” provide an indication of a patient's medical condition. A patient's vital sign is considered “normal” when it falls within a standardized “normal range”. A normal range is a predetermined range of numerical values within which a patient's vital sign should statistically fall in the absence of a medical ailment. Vital sign normal ranges are known by those skilled in the medical arts, and are widely published. The maximum and minimum values for these normal ranges vary depending on the patient's age. However, numerous measurable vital signs exist, and for each vital sign there exists numerous possible normal ranges. Therefore, is it critical that the medical care provider recognize when a patient's vital sign or signs fall outside the corresponding normal range. Failures to recognize that a vital sign falls outside the corresponding normal range may result in an increased risk of a missed medical care opportunity. Often, such missed medical care opportunities occur when a patient is being discharged from a hospital or the like, and the discharging nurse or physician fail to recognize that the patient's vital signs are abnormal.

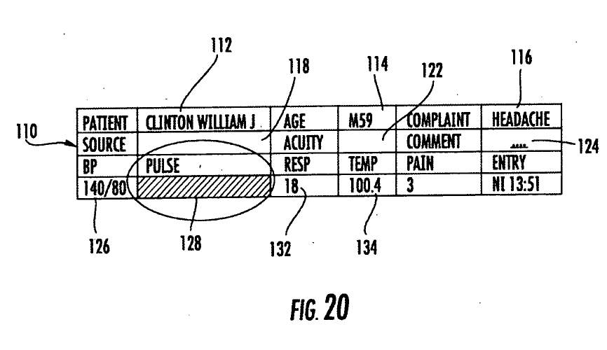

A patient's vital signs may be collected manually by a nurse, physician or other health care provider, or may be collected using commercially available apparatuses capable of collected information such as a patient's blood pressure, pulse, blood-oxygen content, temperature and the like. As shown in FIG. 20, this collected information is displayed on a vital sign template 110. The patient's vital signs are visible when looking at the screen. A warning is provided automatically when the vital signs are severely abnormal or above normal.

In the preferred embodiment, the vital sign template 110 includes a “patient” field 112 for displaying the patient's name, an “age” field 114 for displaying the patient's age, a “complaint” field 116 for displaying the patient's chief complaint, a “source” field 118 for displaying the source or location of the patient's chief complaint, an “acuity” field 122 for displaying the acuity level of the complaint, and a “comment” field 124 for imputing and/or displaying comments regarding the patient. Fields for displaying the patient's blood pressure 126 (labeled “BP), pulse 128 (labeled “pulse”), respiratory rate 132 (labeled “resp”) and temperature 134 (labeled “temp”) are provided. This information can be automatically imported from the above-noted commercially available vital sign collection apparatuses, inputted manually directly into the template 110, and/or imported from another template.

The numerical values for each of the patient's vital signs are compared against normal ranges stored in the medical risk database 14. Where a vital sign falls outside the normal range for a typical patient, the medical care provider is alerted visually and/or audibly that the particular vital sign falls outside the corresponding normal range. By alerting the medical care provider as such, they can then intervene to determine whether medical attention is required, thus substantially reducing the risk of a missed medical care opportunity.

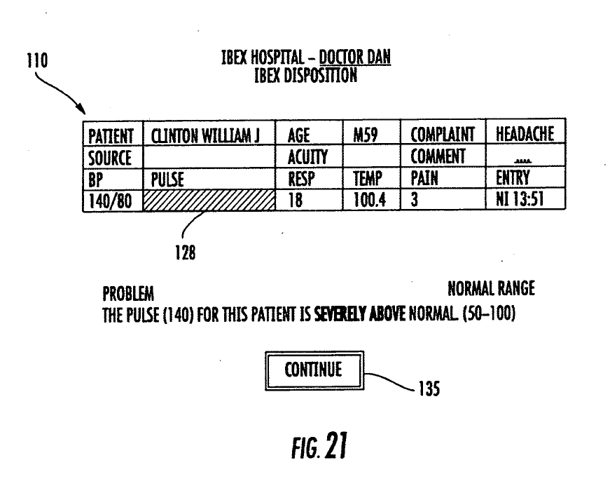

FIG. 21 is an example of a completed vital sign template 110 as viewed by a discharge nurse or physician as a patient is being discharged. In this example, the patient's pulse as displayed in the pulse field 128 has a value of “140”. The pulse normal range stored in the medical risk database 14 for a statistically similar patient is 50 to 100. In this case, the patient's pulse falls outside the corresponding normal range. To visually alert the discharge nurse or physician of this fact, the pulse field 128 is highlighted, preferably in red. By alerting the discharge nurse or physician of this abnormal vital statistic, the risk of overlooking this abnormal value is substantially reduced, thus substantially reducing the risk of a missed medical care opportunity.

As a further warning or alert to the discharge nurse or physician, when a “discharge” button (not shown) is selected by the discharge nurse or physician (thereby indicating that the patient is being discharged), a visual statement appears on the communication device 18 indicating the exact abnormal vital sign, and displays the normal range for that vital sign. To continue with the patient discharge, even in light of this warning, the discharge nurse or physician must select a “continue” button 135. The system 10 then records the fact that a warning was provided to the discharge nurse or physician, and that the discharge nurse or physician selected the “continue” button 135 despite the information contained in the warning. The system 10 then later generates a report based on this recorded information that can later be used for assessments, teaching, litigation, etc. regarding what actions were specifically taken by the discharge nurse or physician, and whether such actions were proper or improper.

Report Generator

All information input into the system by all users is recorded by the system 10, and this information is later collated to generate a printed report. For example, after the user has finished completing all of the relevant templates 24, 84, 110, the system 10 generates a report indicating the information contained therein, even if such information indicates that no observations were present or observable for a particular condition. This report can later be used for assessments, teaching, litigation, etc. regarding what actions were specifically taken by the user, and whether certain observations were made.

Allergy and Drug Interaction Alerts

Alerting medical personnel (i.e. physicians, nurses, pharmacists and the like) that a patient has a particular allergy substantially reduces the risk of missed medical care opportunities. Computer software currently exists which can be utilized to notify medical personnel who are responsible for a given patient's care of that patient's allergy. In addition, such software can alert a medical care provider when a given course of treatment is likely to trigger an allergic reaction. Such software is widely commercially available, and one with ordinary skill in the art could select the appropriate allergy and drug interaction software for their needs and implement the software in conjunction with the present invention. Typically the patient allergy is conveyed from the patient to a medical care provider during triage and manually inputted, automatically imported from an independent database, or where such software is used in conjunction with the present invention, that this information is contained in a preexisting patient data record 22 already stored within the system 10.

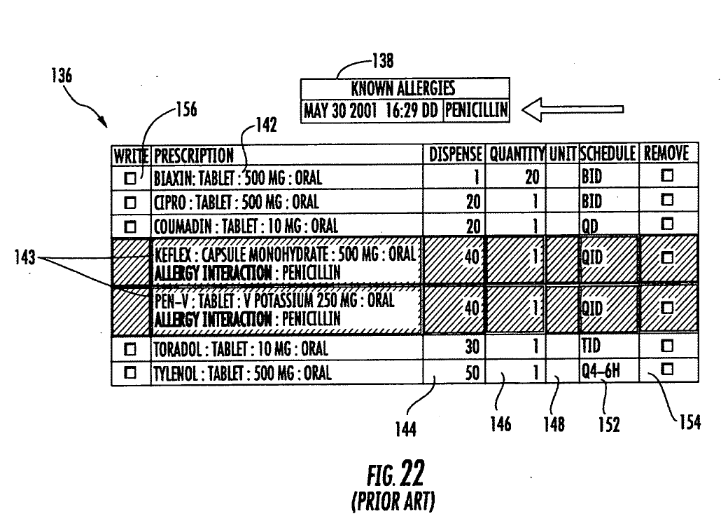

FIG. 22 is a screen illustration of a prescription medicine template 136 provided by an allergy and drug interaction software program. The prescription medicine template 136 displays for a medical care provider a list of all medications currently prescribed for a patient, and is a means by which the medical care provider can add and remove prescription medications to and from the list. The template 136 includes a patient “known allergy” field 138 that displays all known allergies associated with the patient. A “prescription” field 142 displays the name, form (i.e. liquid, tablet, and the like), dosage, and delivery form (i.e. oral, intravenous and the like) of the medication. A “dispense” field 144 lists the number of times the prescription is to be filled. A “quantity” field 146 lists the numerical value for the amount of medication to dispense, and a corresponding “unit” field 148 lists the units of measurement (i.e. milliliters, “cc's” or cubic centimeters or the like) for the numerical “quantity” field 146 value. A “schedule” field 152 lists the time or frequency the medication is to be administered to the patient. “Remove” and “write” check fields 154, 156 allow a medical care provider to remove a prescription from the list of medications to be administered, and to add a prescription to the list of medications to be administered, respectively.

In the example provided in FIG. 22, the medical care provider added penicillin to the list of medications to be administered to the patient. However, as can be seen in the patient “known allergy” field 138, this particular patient is allergic to penicillin. When the medical care provider added penicillin to the list of medications to be administered to the patient, the entry was compared against the patient data record, and a conflict was recognized by the system. Once the conflict was recognized, the software then prevented prescription from being added to the list of medications to be administered to the patient. In the preferred embodiment, not only is the medical care provider prevented from adding the possibly allergic reaction inducing medication to the list of medications to be administered to the patient, but also an audible and/or visual alert notifies the medical care provider of this conflict and the medical care provider is provided with possible alternatives to the possibly allergic reaction inducing medication. In this example, the software visually alerted the medical care provider as to the conflict by highlighting the prescription field generally indicated by reference number 143 and color altering the field 143 to make it substantially more noticeable, and alternative medications were listed.

Not only does the software compare all newly entered prescriptions against patient allergy information contained in the patient data record 24, but the software also compares the prescription against information contained in the medical risk database 14 to determine if a “drug interaction” exists between the newly entered prescription medication and prescription medication already being administered to the patient. A “drug interaction” occurs when two or more medications are administered to the patient, and those medications interact with each other to produce undesired side effects. If a “drug interaction” exists, an audible and/or visual alert notifies the medical care provider of this “drug interaction” and notifies the medical care provider which drugs may cause the “drug interaction”.

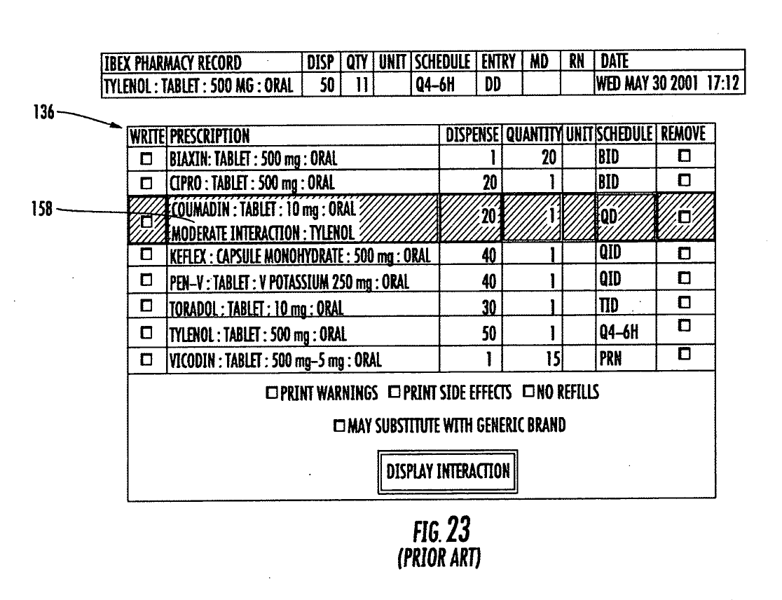

FIG. 23 is an illustration of an example of a prescription medicine template 136 where a “drug interaction” has been detected. In this case, when the medical care provider added the drug Coumadin to the list of medications to be administered to the patient, the entry was compared against the other medications already listed and against information contained in the medical risk database 14, and a “drug interaction” was recognized by the software. Once the “drug interaction” was recognized, the system 10 visually alerted the medical care provider as to the “drug interaction” by highlighting the corresponding prescription field (indicated by reference number 158) and color altering the field 158 to make it substantially more noticeable. Also, the name of the drug with which Coumadin is likely to interact with is also listed, namely, Tylenol. By using the allergy and drug interaction software program in conjunction with the present invention, medical personnel are alerted (i.e. physicians, nurses, pharmacists and the like) of potential “drug interactions,” thus substantially reducing the risk of missed medical care opportunities.

### EXAMPLE 1

### Abdominal Pain

| Patient Data | Medical Risk | Proposed Response |
|---|---|---|
| The patient | A pregnant patient suffering | Perform an ultrasound |
| is pregnant | from abdominal pain may | study of the fetus and |
| | have an ectopic pregnancy, | surrounding maternal |
| | which is not necessarily | tissue. |
| | determinable by physical | |
| | examination and may be | |
| | misdiagnosed as another | |
| | condition. | |
| woman of child | Patients reporting | Test for pregnancy |
| bearing age with | information inconsistent | |
| abdominal pain | with pregnancy, such as | |
| | abstinence from | |
| | intercourse, recent | |
| | menstruation, or the use of | |
| | contraceptives often are | |
| | nonetheless pregnant. | |
| | When a pregnant person | |
| | presents abdominal pain, | |
| | the diagnosis of | |
| | ectopic pregnancy should | |
| | be considered. | |
| sudden onset of | A vascular event that | Test for a vascular |
| abdominal pain | requires quick treatment, | event |
| | such as abdominal aortic | |
| | aneurysm (AAA), may have | |
| | occurred. AAA is often | |
| | overlooked, as it can be | |
| | difficult to diagnose. | |
| The patient's | An AAA, which requires | Test for AAA |
| abdominal pain | quick treatment, may have | |
| radiates to the | occurred. | |
| back or | | |
| to the flank. | | |

### EXAMPLE 2

### Neck Pain

| Patient Data | Medical Risk | Proposed Response |
|---|---|---|
| Blunt spine | In a number of cases, | Blunt spine injury is |
| injury | liability has been found | treated with high dose |
| less than | because the patient was | methylprednisolone if |
| eight hours | diagnosed with a spinal | treatment is begun within |
| before the | cord injury several hours | eight hours of the injury. |
| time of | (but fewer than eight | The literature does not |
| diagnosis. | hours) after the injury, but | demonstrate any benefit |
| | methylprednisolone | beyond eight hours. |
| | treatment to reverse the | 30 mg/kg bolus |
| | effects of spinal cord | administered IV over |
| | injury was not started | 15 min. |
| | early enough to improve | 45 min. pause |
| | the patient outcome. | Maintenance infusion 5.4 |
| | | mg/kg/hr for 23 hours |
| The patient | The intoxication may | Liberal ordering of the |
| is | mask the effects of | trauma C-Spine series is |
| intoxicated | cervical spinal cord injury | recommended in this |
| with alcohol | or render the patient | setting. |
| or other | unable or unwilling to | |
| intoxicants. | cooperate. | |
| Neck pain, | Spinal cord injuries do | Don't rely solely on |
| but no | not always coincide with | the absence of radiological |
| radiologic | spine damage visible on | abnormality and of present |
| (i.e. bone) | x-rays or stable | neurological symptoms. |
| abnormality | neurological changes. | Look carefully at EMT |
| in the x- | Transient neurologic | (emergency medical |
| ray and no | changes may occur before | technician) and nursing |
| apparent | the emergency department | notes relating back to the |
| neurological | visit, and not be present | time of the injury. |
| changes. | in the emergency | If there is prior evidence |
| | department. Spinal Cord | of a neurologic sign or |
| | Injury Without | symptom, neurosurgical |
| | Radiological Abnormality | consultation, a |
| | (SCIWORA) is often very | period of observation or |
| | difficult to diagnose, | hospital admission are |
| | sometimes with | recommended. |
| | catastrophic results. | |

### EXAMPLE 3

### Chest Pain

| Patient Data | Medical Risk | Proposed Response |
|---|---|---|
| Chest Pain | This is a characteristic | Consider the diagnosis of |
| Radiating | symptom of Thoracic | TAD |
| to the Back | Aortic Dissection (TAD), | Measure bilateral arm |
| | which is often missed in | blood pressure, if |
| | diagnosis because it often | possible. |
| | resembles other, less- | Look at the x-ray |
| | critical conditions. TAD | specifically for signs of |
| | must be quickly | TAD (e.g. abnormal |
| | diagnosed and treated to | aortic contour, widening |
| | avoid death. | or mediastinum, |
| | | deviation of the trachea |
| | | or mainstem bronchi). |
| | | Document your |
| | | observations. |
| Chest pain | Where chest pain is the | Do one of the following: |
| PLUS: | only clinically apparent | Obtain cardiology |
| One major | symptom of an acute | consultation |
| risk factor | myocardial infarction | Observation status to |
| (smoking, | (AMI), that diagnosis is | rule out myocardial |
| hypertension, | often prematurely ruled | infarction |
| diabetes, | out in favor of other | Admit |
| family history | possible conditions (often | |
| (Hx), high | due to coinciding | |
| cholesterol) | symptoms of lesser | |
| or | problems, like | |
| A history of | indigestion) and the | |
| coronary | patient is discharged. | |
| artery | This delayed or missed | |
| disease | diagnosis frequently | |
| | results in death of the | |
| | patient. | |

### EXAMPLE 4

### Headache

| Patient Data | Medical Risk | Proposed Response |
|---|---|---|
| This is | This is a two-step risk. First, | (1) Order a non-infused |
| reported as | a very bad headache may be | CT of the head to rule |
| the worst | caused by a subarachnoid | out a subarachnoid |
| headache | hemorrhage. Even though | hemorrhage. |
| of the | few severe headaches are | (2) Proceed with lumbar |
| patient's | caused by a subarachnoid | puncture even if the CT |
| entire | hemorrhage, the patient | of the head is read as |
| life. | outcome is poor unless the | negative for bleeding. |
| | condition is quickly | |
| | diagnosed and treated. | |
| | Second, even if a 4^{th} | |
| | generation CT of the head is | |
| | carried out, sometimes it will | |
| | not be read as showing | |
| | bleeding when the patient in | |
| | fact has a subarachnoid | |
| | hemorrhage. | |

### EXAMPLE 5

### Testicular Pain

| Patient Data | Medical Risk | Proposed Response |
|---|---|---|
| Abdominal | Torsion of the testicle | Consider torsion in the |
| pain, but | is a difficult | differential diagnosis. |
| no | diagnosis, and is | |
| testicular | often missed, as often | |
| pain | the patient's site of | |
| | discomfort is in the | |
| | abdomen, rather than | |
| | the testicles. | |
| Sudden | Sudden onset of | Immediately consider the |
| onset | severe pain should | diagnosis of torsion |
| of pain | rule out epididymitis, | testicle |
| | but often does not. | |
| | Torsion testicle must | |
| | be immediately | |
| | diagnosed, since | |
| | salvage of the testicle | |
| | is only highly | |
| | probable within six | |
| | hours of the onset of | |
| | pain. | |

Vital Sign Trending Graphs and Warnings

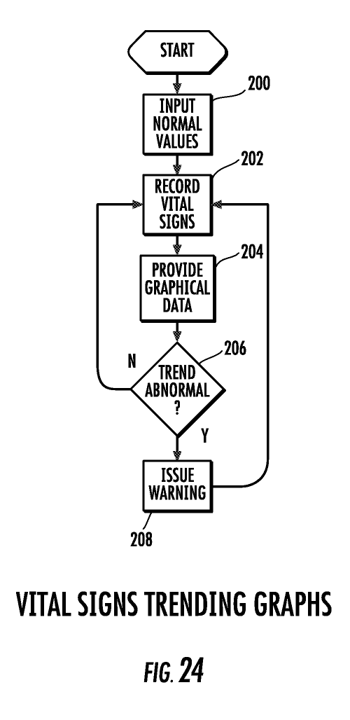

A flow chart of the vital sign trending graphs feature is shown in FIG. 24. The vital sign trends of a patient are critical to monitor in order to reduce the risk of a missed, erroneous or delayed diagnosis and/or treatment and protect patient safety. The vital signs information of the patient and the vital signs information contained in the medical risk information include: pulse rate; blood pressure; temperature and respiratory rate. However such trends are easily missed if merely presented in a table to the healthcare provider. Providing data showing that the patient's pulse has been going up steadily for six hours in graph form is much more likely to be noticed and properly reacted to by the health care provider.

In the preferred embodiment of the present invention, as shown in FIG. 24, the system stores or accesses normal vital sign values as well as normal vital sign variation that have been inputted or otherwise entered or available in step 200. Vital signs for the patients are then recorded over time in step 202. The trend for the variation of any of such vital signs over time is then displayed in step 204 to the healthcare provider in graph form. A comparison is made in step 206 between such trends and the normal variation data as well as the significance of trends therein showing increases or decreases in any of the patient vital sign trends over time stored or accessible as part of the medical risk information in the system. If such trends are abnormal over a particular time, so as to show a serious condition, then a visual, audio and/or other type of noticeable warning is issued in step 208 to the healthcare provider.

For example, if a patient's arterial blood pressure has been decreasing over time, even if the blood pressure remains within normal or acceptable blood pressure limits, the trend demonstrates a constant fall and is indicative that the patient is septic. If not acted upon, the patient may suffer serious injury or die.

Pulse Temperature Disparity Table

Normally, the pulse rate and temperature of a patient should be in sync. Pulse elevation not in sync with body temperature is an indicator of pain, anxiety or a significant physiologic abnormality. One embodiment of the present invention includes a temperature/pulse look-up table with associated warnings to the health care provider in the event that there is a significant discrepancy. This is consistent with the goals of reducing the risk of missed, erroneous or delayed diagnosis and/or treatment and promoting the quality of healthcare so as to promote patient safety.

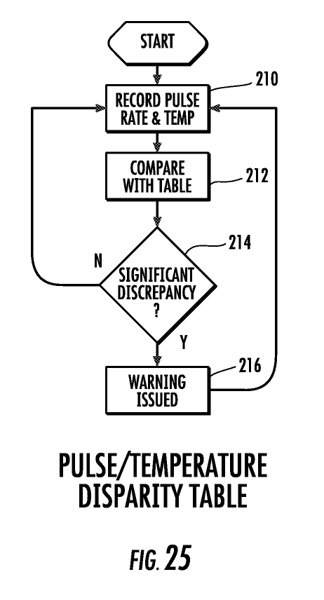

Turning to FIG. 25, the pulse rate and temperature of the patient are recorded in step 210. The relationship between the pulse rate and temperature is compared in step 212 with a table of normal values or a range of normal values that is contained in or accessed by the collection of medical risk information of the system. If a significant discrepancy is found in step 214, a warning is issued in audio and/or visual form or other form in step 216 for the healthcare provider to look for the condition possibly causing such abnormality. For example, the practitioner is warned to eliminate such minor causes as anxiety and test for more serious conditions such as sepsis or a pulmonary embolism. In this way, as with the other types of warnings or prompts of the present invention, a failure to test for and/or correctly or timely diagnose a serious illness or condition can be avoided.

Risk Alerts

Healthcare providers often need help remembering the thousands of things associated with medical care. In those situations where there is an increased risk of a missed, delayed or erroneous diagnosis and/or treatment, such alerts are triggered by something the health care provider inputs or fails to input about the patient's condition or symptoms into the system. They serve to assist in making a diagnosis, remember a treatment, or provide other such critical reminders in the interests of promoting quality healthcare and patient safety. For example, if the physician or nurse indicate that an elderly patient with abdominal pain has pain in the upper abdomen, a risk alert becomes available in the medical chart reader saying, “upper abdomen pain in the elderly,” and is hyperlinked and provides a warning to consider coronary artery disease and order an electrocardiogram.

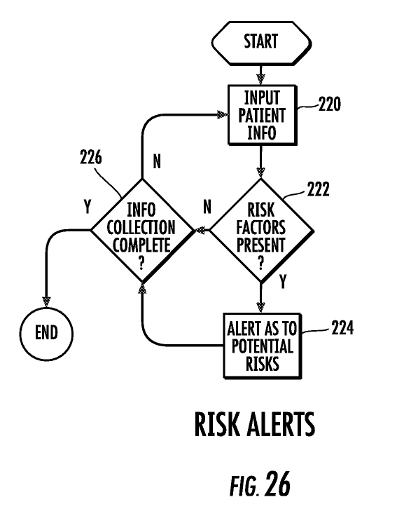

Turning to FIG. 26, this Risk Alert process is illustrated as follows. The patient information is inputted in step 220. A comparison is made in step 222 with the information contained or accessed by the collection of medical risk information of the system. If a risk of missed or erroneous diagnosis or treatment is present based on the input patient information, then a Risk Alert is provided in step 224 to the physician to consider additional information, gather more information, or perform additional tests. If no risk factors are present, then the system will determine in step 226 if more information about the patient is needed or desired. Additional information may then be inputted in step 220 until the patient record or collection of patient information is complete.

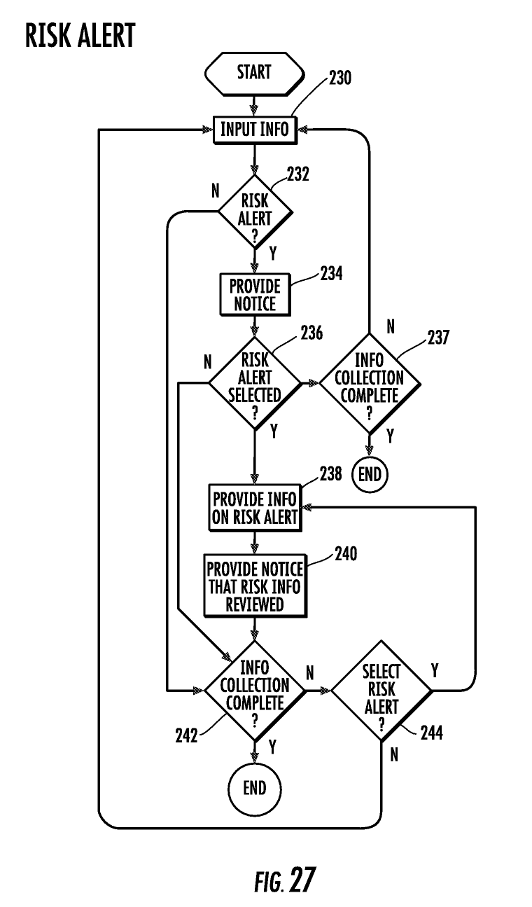

FIG. 27 provides a more detailed flow diagram of the Risk Alert process. The patient information inputted in step 230 is compared in step 232 to the information contained in or available to the collection of medical risk information otherwise referred to herein as the database. If an increased risk exists, a notice is provided in step 234 to the physician or nurse. If the notice is selected, the information is provided to the physician or nurse in step 236 regarding the subject of the Risk Alert. A notice may then be provided in step 240 that the Risk Alert information has been reviewed. If the risk alert is not selected in step 236, then the system will determine whether the patient record or collection of patient information is complete in step 237 before ending or accepting more input. If the collection of necessary patient information is complete, the Risk Alert ends. If not, and if a Risk Alert is selected, additional information is provided to the healthcare provider. If it is determined in step 242 that the information collection process or patient record is not complete and a Risk Alert is not selected in step 244, then the input of information continues. In one embodiment of the present invention, there are no popup reminders regarding Risk Alerts and the practitioner is not required not select or follow the Risk Alert notice.

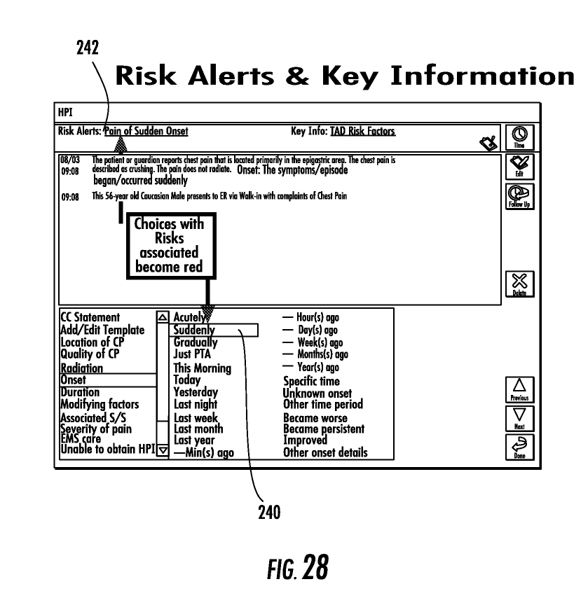

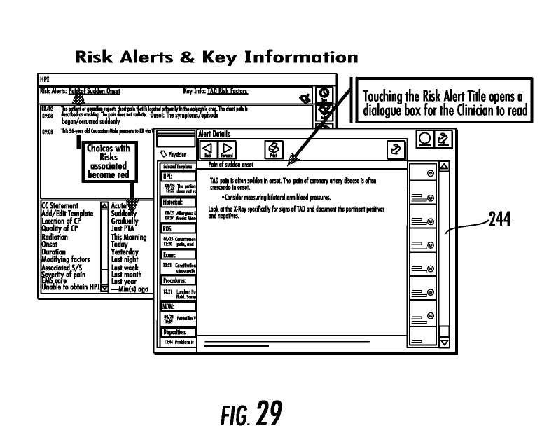

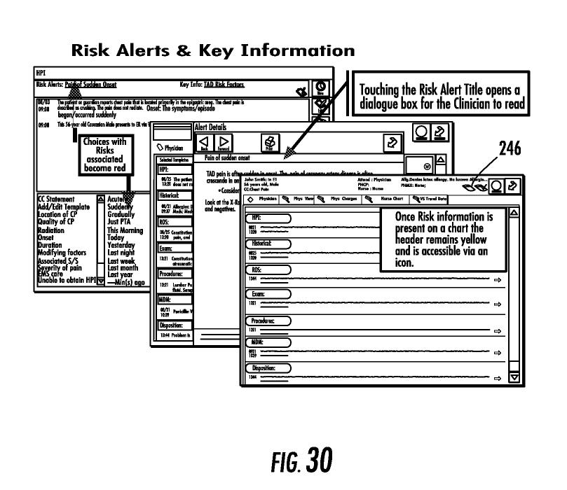

Turning to the screen shot of FIG. 28, to alert the healthcare provider, choices 240 associated with risks turn a different color, in this case red. Selecting the Risk Alert title 242, as shown in the screen shot of FIG. 29, opens a dialogue box 244 for the provider to read and thereby receive additional information regarding the risk situation. Once Risk information is provided on a chart or otherwise to the health care provider, the header remains yellow and the information provided about the Risk Alert is accessible by way of selecting an icon 246.

Key Information

Key information is reference material provided to the practitioner at certain key points in the process of filling in the templates of the medical record. At such key points, such key information is available in one embodiment through a hyperlink in the header. This serves to reduce the risk of a missed, erroneous or delayed diagnosis and/or treatment in the interests of improving the quality of healthcare and patient safety. However, other ways of making such information readily available to the practitioner without having to leave the patient's bedside or the location where the medical chart is being prepared should be considered as being within the scope of the present invention. As with the Risk Alerts, in one embodiment, there are no popups and the practitioner is not required to use such Key Information. As an alternative, a record may be made and retained in the system as to whether the practitioner has accessed such Key Information.

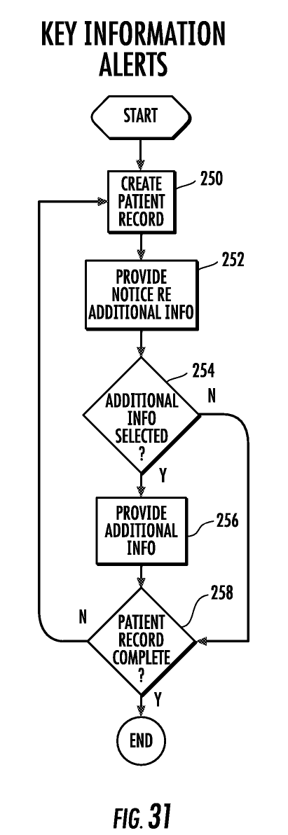

As shown in FIG. 31, as the patient record is created in step 250, the system will compare the information inputted with that information contained in or accessible to the collection of medical risk information of the system and provide notice of available additional information as provided in step 252. If the Key Information Alert is selected in step 254, such additional information is provided to the practitioner in step 256. If not and if the patient record is determined to be complete in step 258, then the Key Information Alert ends.

Critical Alerts

Certain patient related events in the emergency room require immediate notification and attention. For example, these critical items can be lab results showing an extremely high potassium level—which, if left untreated, is likely fatal. Similarly, an antibiotic for a one month old child with a fever must be started within a certain time period or the child could die of suffer significant injuries or damage.

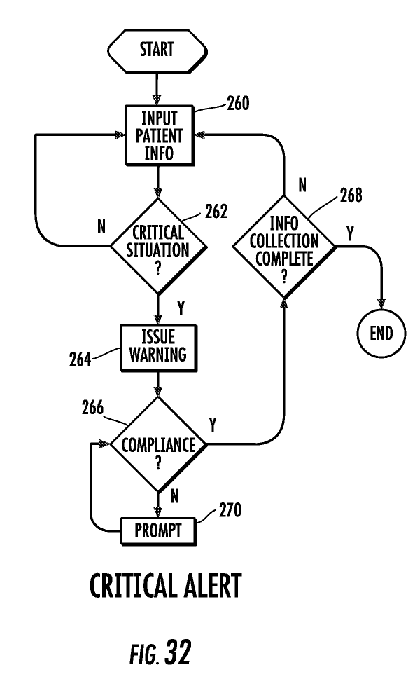

To address these sorts of time critical situations, the present invention provides the Critical Alert process shown in FIG. 32. Based on the patient information that is inputted in step 260, a comparison is made in step 262 with the collection of medical information contained in or accessible to the risk and patient safety database. If a critical situation exists, a verbal, visual and/or other sort of warning is provided in step 264 to the physician. If the system determines in step 266 that based on information inputted that the health care provider has complied with or otherwise properly responded to the issued warning and the information collection process is determined to be complete in step 268, then the Critical Alert ends. If the system determines that the health care provider has not complied with or otherwise properly responded to the issued warning, a prompt is provided to the caregiver in step 270.

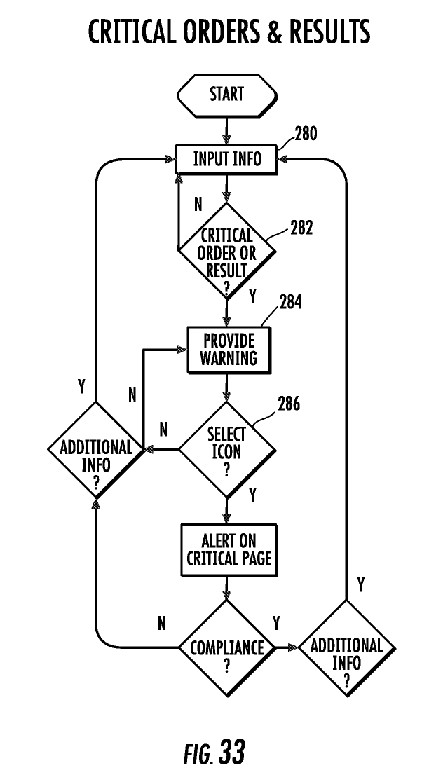

A more detailed description of the Critical Orders and Results process of the Critical Alerts process is shown in FIG. 33. As described above, a warning is provided to the healthcare provider in step 284 if Critical Orders or Results are detected based on the comparison in step 282 of the patient information inputted in step 280 and the information accessible to or contained in the medical risk and patient safety database (“risk database”). If the Critical Alert icon is selected in step 286, an alert is provided to the healthcare provider in step 288 which also appears on the critical page of the patient chart.

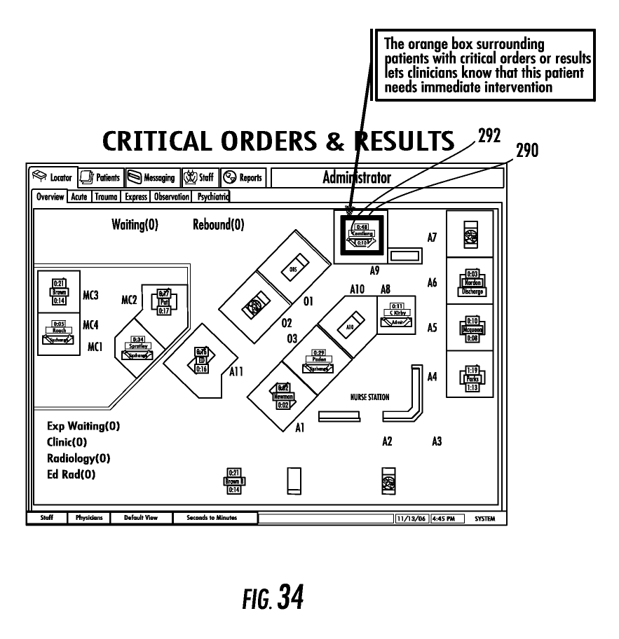

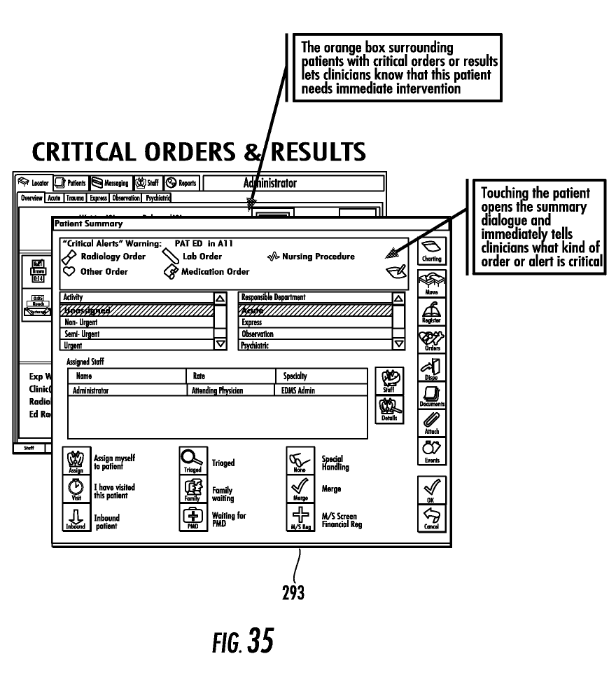

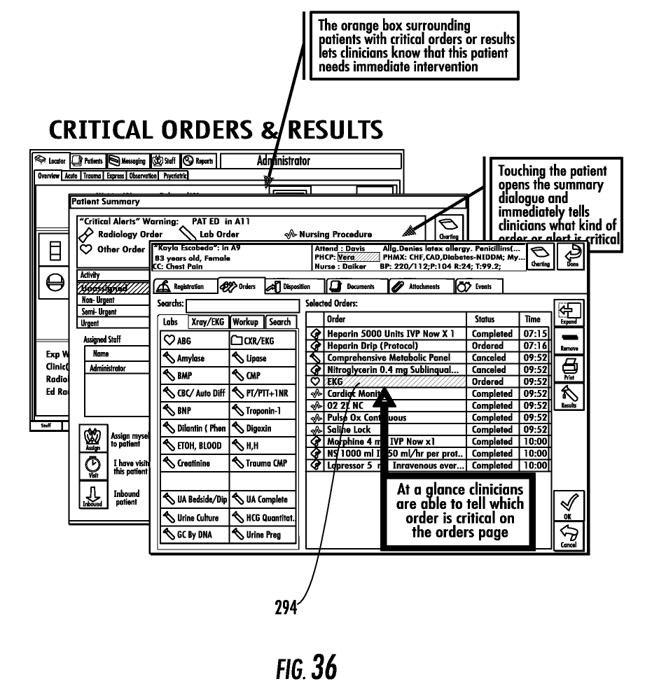

As shown in the screen shot of FIG. 34, in this example, an orange box 290 surrounds the icon representing the location in the ER on the display of a patient with Critical Orders or Results to let the healthcare providers know that this patient needs immediate intervention. Selecting the icon 292 representing the patient, serves to open the patient summary page 293 as shown in the screen shot of FIG. 35, so as to immediately tell the healthcare professional which order or alert is critical. Similarly, as shown in the screen shot of FIG. 36, the critical order 294 is highlighted, in this example in red, on the orders page. In these ways, the risk of a missed, erroneous or delayed diagnosis and/or treatment is reduced and the safety of the patient is protected.

Seconds to Minutes Chief Complaints

Some patient presentations in the emergency room are of the highest priority in terms of the need for the healthcare provider to recognize the potential for loss of life or limb in a time period as short as literally “seconds to minutes”. On patient arrival to the emergency room, the system provides a list to the initial caregiver, usually a nurse, of general conditions so critical, that the patient could die in seconds to minutes if proper care and treatment is not provided.

This list is the first thing for the nurse to look at. If any of the conditions on this list are clicked on, warnings are provided to the nurse and Emergency Room doctor. Examples of these situations are: chest pain (which could result in loss of heart muscle); scrotal pain (which could result in loss of a testicle); and abdominal pain in the elderly (which could be the result of abdominal aortic aneurysms).

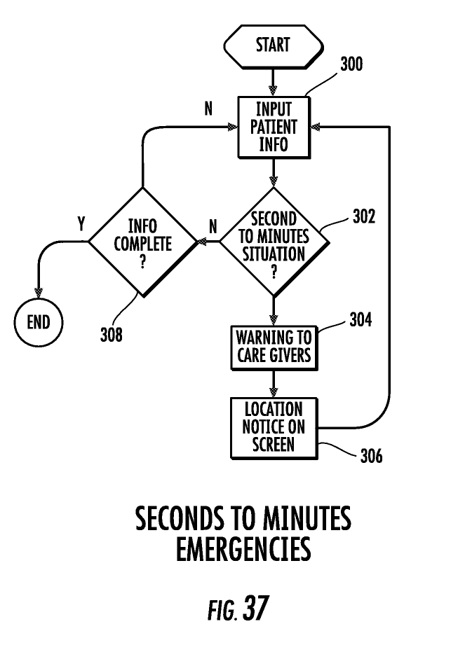

The present invention addresses these most critical situations and the need for immediate recognition and treatment thereof with the Seconds to Minutes process shown in FIG. 37. In this way the risk of a missing, erroneous or delayed diagnosis and/or treatment is avoided, the quality of healthcare is improved, and the safety of the patient is protected. The patient information inputted in step 300 is compared in step 302 by the nurse or physician to those several conditions contained the Seconds to Minutes Emergency List. The relevant entry on the list is clicked on and a warning is given in step 304 to the nurse and the Emergency Room (“ER”) doctor. In that way, the patient having symptoms consistent with one of the conditions on the Seconds to Minutes Emergency List will be given top priority and seen immediately by the doctor on duty.

A visual indicator such as a yellow glow may be provided in step 306 on the system display so as to indicate the location of the Seconds to Minutes emergency patient, until the doctor takes over the case from the nurse. The case may also show up with a warning on the tracking board, such as a bright red warning that will remain on unless and until the chief complaint of the patient is changed. Other types of visual, audio and/or other types of warnings should be deemed as being within the scope of the invention. If it is determined in step 302 that there are no Seconds to Minutes situations and it is determined in step 308 that the patient record or collection of information pertaining to the Seconds to Minutes situations is complete, the Seconds to Minutes Emergencies alerts will end. Alternatively, this alert may continue for the entire period that the patient is in the ER.

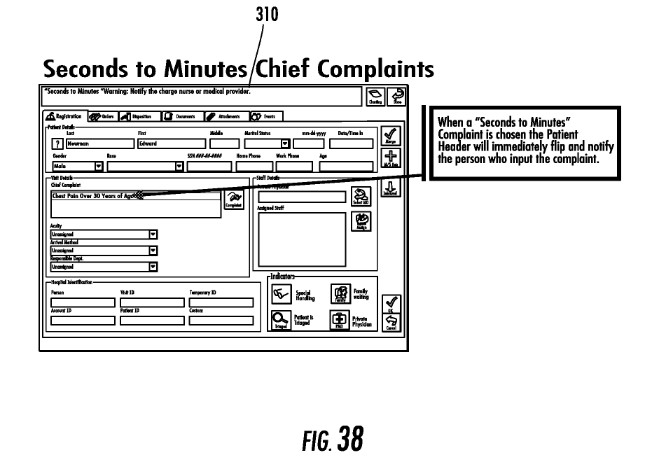

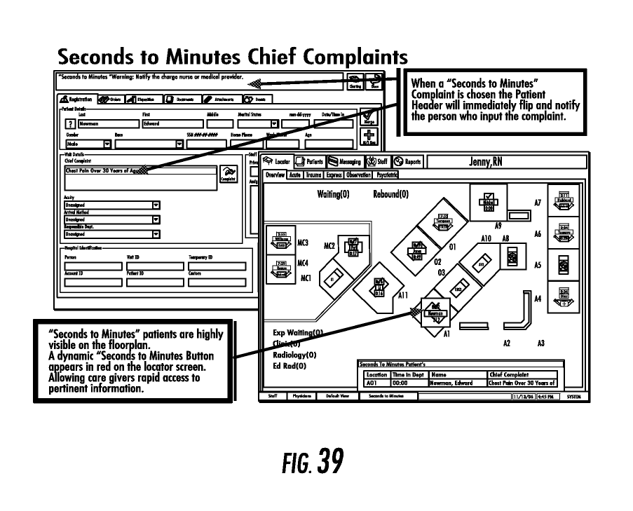

Turning to the screen shots of FIGS. 38 and 39, when a “Seconds to Minutes” chief complaint is selected, the Patient Header 310 immediately notifies the provider of the Seconds to Minutes condition and changes color so as to be more likely to be noticed. On the screen shot of FIG. 39, the icon 312 signifying the patient's location on the floor plan is surrounded in red, in this example, to allow the caregivers to know at a glance which patient or patients are in the Seconds to Minutes situation. It is appreciated that other means of indicating the conditions or patient location may be used and not depart from the scope of the present invention.

Conditional Prompts

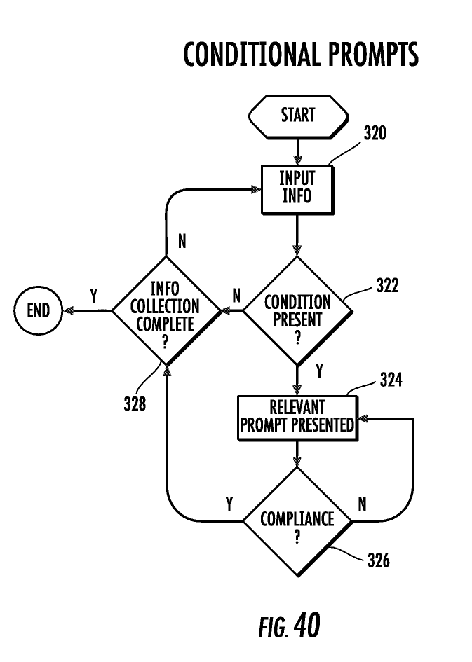

Some elements in the templates of the medical record turn on a relevant prompt, based on the inputted patient information, without specifically providing an additional question for the health care provider to answer. The system correlates the inputted information by comparing it with the information in or accessible to the medical risk database and automatically turns on a prompt. As shown in FIG. 40, based on the information inputted in step 320, if a specified condition is determined to be present in step 322, a relevant prompt is presented in step 324. If it is determined in step 326 that the prompt has been complied with and if all necessary information is inputted in step 328, the Conditional Prompt ends. In this way, the risk of a missed, erroneous or delayed diagnosis or treatment is reduced, the quality of healthcare is improved and the patient's safety is protected.

Dynamic Content

As information is inputted about a patient, the template content is filtered with respect to the information in the medical risk database, based on the age and sex or some other condition or attributes of the patient. The healthcare provider is then provided with required choices that are specific and relevant to that type of patient population or presentation. For example, a patient presenting with loss of consciousness and a headache will be offered the risk factors regarding subarachnoid hemorrhage risk factors. Hence, this feature is referred to as “Dynamic Content”.

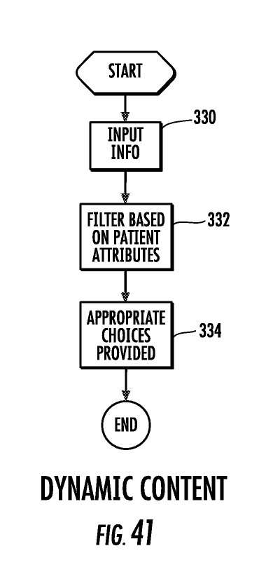

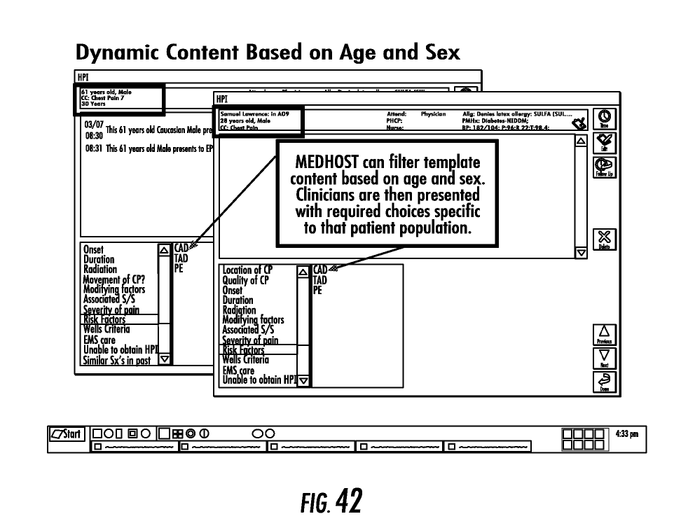

As shown in FIG. 41, based on the patient information inputted in step 330, the choices on such things as Risk Factors are filtered in step 332 based on such conditions or attributes as the age of the patient so that the most relevant choices are provided, in step 334. For instance, as shown in the screen shot of FIG. 42, whether the patient is a 61 year old male or 28 year old male results in different inquiries to the healthcare provider to input different information about the patient. In particular, the choices for a 28 year old male suffering chest pain include access to risk factors for Coronary Artery Disease (CAD), while, due to the increased age of the 61 year old, the choices also include access to risk factors for Thoracic Aortic Dissection (TAD) and Pulmonary Embolism (PE). In this way, the risk of a missed, erroneous or delayed diagnosis is reduced and patient safety is protected.

Evidence Based Medicine

Currently, there is a desire in the medical community to practice medicine in such a way as to be consistent with evidence from the medical literature. Stated another way, if enough medical literature exists to suggest that a certain course of treatment or management is appropriate in a particular set of conditions, then the practitioner is told whether or not those conditions are met. An example of this is where the literature states that if five conditions are met, it is appropriate to remove the cervical collar and remove a car accident victim from the board he was carried into the ER on, without an x-ray. Accordingly, the collection of medical risk management information includes information about treatment as well as patient management. Prompts going to those five elements will be provided to the practitioner and will generate a response based on the inputted information if those five elements have been met. This serves to reduce the risk of a missed, erroneous or delayed diagnosis, and/or treatment, and improving the quality of healthcare while tending to promote patient safety.

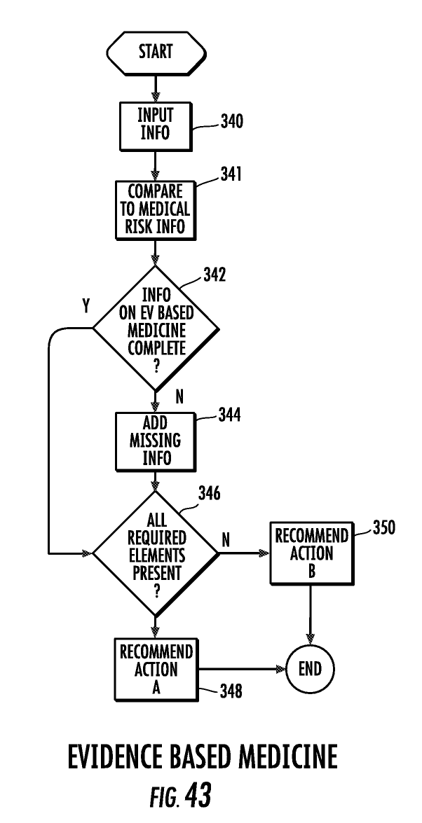

Turning to FIG. 43, if an Evidence Based Recommendation relates to the information inputted in step 340, prompts and recommendations as to the elements of the Recommendation as to treatment or management of the patient situation will be provided automatically in steps 342 and 344 to the practitioner. In one embodiment, the information is inputted 340, then compared to the collection of medical risk information in the risk database 341. If the information needed regarding the elements of the evidence based medicine is not complete 342, then the missing information is added by the practitioner 344. If all of the elements required for the evidence based medicine action are present in the patient situation 346, then the recommendation to the practitioner is to take that action 348. If not, then a different action is recommended 350. For example, in one embodiment, based on the initial patient information, the practitioner is asked by the system to provide input regarding the patient on the five elements based on the medical literature, of whether to x-ray a patient with a neck injury prior to removing the cervical collar. If all five factors of the evidence based medicine are met, the recommendation provided by the system is to skip the x-ray. If one or more of the five evidence based elements are not met, the practitioner is told to order the x-ray.

Rules Engine

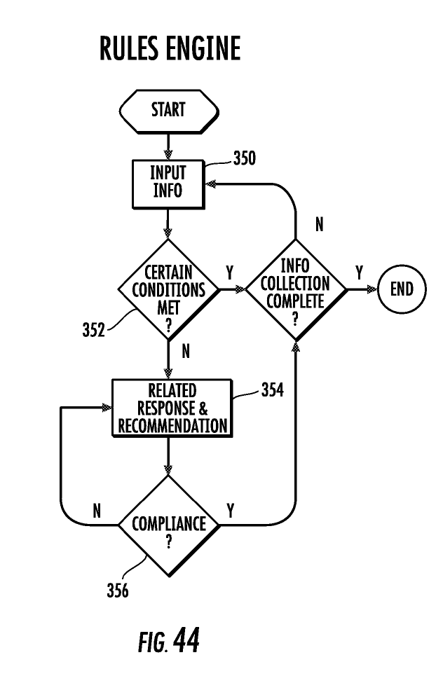

If certain conditions are present, based on a comparison of the inputted patient information and that information accessible to or contained in the risk database, the provider will be prompted to respond to a related question, or take some action. For example, if the registration clerk identifies the condition that a child is 5 days old, and the nurse documents that the child has a fever, then the physician is prompted to identify the presence or absence of a critical third condition, i.e. whether the child was exposed to herpes in the maternal birth canal. If the three conditions are met, this results in a recommendation to provide a certain antibiotic within a certain time frame. This does not rely upon prompting. The engine just looks for conditions. Certain combinations of conditions result in requests for more information or recommendations to take some action. This information is compared to that of the medical risk database and a recommendation is made to treat the child with a certain antibiotic immediately. Delay in providing such antibiotic treatment would result in life long disability. Turning to FIG. 44, if certain conditions are met in step 352 based on the information inputted in step 350, a related response and recommendation are provided in step 354. In one embodiment, the practitioner must respond or comply with the recommendation in step 356 prior to proceeding. Accordingly, the risk of a missed, delayed or erroneous treatment and/or diagnosis is avoided and the quality of healthcare is improved, in the interests of patient safety.

Interactive Differential Diagnosis

In order to identify the medical condition to be treated, the physician begins by observing the patient's symptoms, examining the patient and taking the patient's personal and family history. The most likely causes for the symptoms are then listed. This process is referred to as “differential diagnosis”. Questions are then asked and tests are performed to eliminate some of the possibilities until the most likely cause is identified.

Often the practitioner needs assistance in considering an appropriate differential diagnosis. At times, the practitioner requires additional information about certain items in the differential diagnosis. A differential diagnosis is provided for the high risk chief complaints and that differential is interactive. Through a hyperlink the practitioner has access to critical information about a particular diagnosis. This improves the physician's opportunity to make a correct diagnosis, or to decrease the likelihood of missing the diagnosis and/or delaying or failing to provide proper treatment. In that way the practitioner need not leave the patient's bedside for additional information. Preferably, the differential diagnosis is provided to the practitioner in such form as: “Based on the medical literature you may have made the following diagnoses . . . ” In that way the practitioner is provided the benefit of comparing his or her diagnosis with the possible Interactive Differential Diagnoses. Hence, the risk of a missed, erroneous or delayed diagnosis and/or treatment is avoided, and the quality of healthcare is improved in the interest of patient safety.

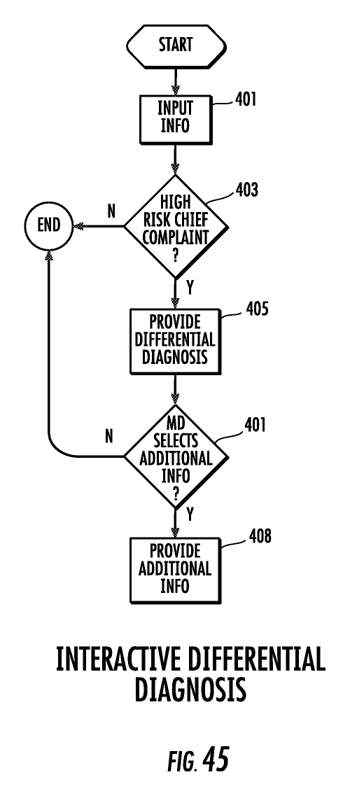

Turning to FIG. 45, patient information is inputted 401. By comparing such information to the medical risk database, it is determined whether a high risk chief complaint is present 403. If so, a differential diagnosis is provided 405. If the healthcare provider selects additional information on the differential diagnosis 407 it is provided 408.

The screen shots provided herein are merely examples of how the features and operations of the present invention can be embodied as a risk overlay in a computerized emergency room medical chart system and should not be deemed to limit the scope of the invention in any way. One such example of such an underlying computer-based electronic Emergency Room medical chart system is that of Medhost illustrated in the figure herein.

The foregoing description of an embodiment of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims as set forth below.

What is claimed is:

1. A computerized medical chart system for improving the medical care of patients by communicating with a health care professional preparing a medical record in connection with preparing or recording diagnoses, symptoms, physical examination or other patient information that lead to the diagnosis or treatment, and including important elements of the patient's medical condition, comprising:
a medical risk database containing medical care information regarding a plurality of illnesses, diseases and/or injuries, and further at least containing information regarding increased risks of missed diagnoses;
means for recording the symptoms or other patient information;
means for comparing the recorded symptoms or other patient information with the medical care information stored in the medical risk database to determine the existence of at least one increased risk of a missed diagnosis based on the symptoms or other patient information recorded; and,
means for prompting the health care professional to take particular actions or record additional important items of the diagnoses, symptoms, physical examination, or other patient information in the medical record that lead to the diagnoses or treatment, so as to provide the health care professional with an opportunity to avoid a missed diagnosis and adequately record the action taken.

2. The computerized medical chart system of claim 1 wherein said medical risk database further includes information concerning the risk of at least one of the following: incorrect or delayed diagnosis; or missed, incorrect or delayed treatment.

3. The computerized medical chart system of claim 1 further including means for prompting a health care professional to record symptoms or other patient information relevant to said increased risks.

4. The computerized medical chart system of claim 1 further including means for providing the health care professional with relevant medical care information reducing the risk of at least one missed diagnosis by the health care professional of the plurality of illnesses, diseases or injuries based on the symptoms or other information regarding the patient.

5. The computerized medical chart system of claim 1 further including means for associating said recorded symptoms or other patient information with the relevant medical care information related to the increased risk of missed diagnoses with respect to the recorded symptoms or other patient information.

6. A method for improving the medical care of patients by using a computerized medical chart creation system for communicating with a health care professional preparing a medical record in connection with recording signs, symptoms, physical examinations and other patient information leading to the diagnosis and treatment, and including important elements of the patient's medical condition, the computerized medical chart creation system including a medical risk database having information on a plurality of illnesses, diseases and/or injuries, the method comprising the steps of:
recording said symptoms or other patient information;
comparing said recorded symptoms or other patient information with the information stored in the medical risk database containing at least information regarding the risk of missed diagnoses as to the existence of at least one such increased risk with respect to the symptoms and patient information; and,
prompting the health care professional to take particular actions and include important items of said diagnosis, symptoms, treatment or other patient information in said medical record.

7. The method of claim 6 wherein said medical risk database further includes information concerning the risk of at least one of the following: incorrect or delayed diagnosis; or missed, incorrect or delayed treatment.

8. The method of claim 6 wherein said method further comprises the step of presenting medical care information to said health care professional reducing the risk of a missed diagnosis as to the symptoms and other patient.

9. A computerized risk management system for assisting a health care professional in diagnosing, treating and documenting actions taken with respect to possible illnesses, diseases or injuries of a patient, associated with a computerized medical chart preparation system comprising:
a medical risk database containing information regarding a plurality of illnesses, diseases and/or injuries, and comprising medical care information regarding at least increased risks of missed diagnoses;
means to input data concerning the patient symptoms into a patient data record;
a data processor, wherein the data processor compares the recorded patient symptoms in the patient data record with the medical care information in the medical risk database to determine the existence of an increased risk of at least one missed diagnosis of the patient having one or more of the illnesses, diseases or injuries; and,
means for prompting the health care professional to take appropriate action and record relevant patient information and the actions taken by the health care professional with respect to the patient in the medical record, so as to provide the health care professional with an opportunity to avoid at least a missed diagnosis, and adequately document the diagnosis of said illnesses, diseases or injuries and the actions taken.

10. The computerized risk management system of claim 9 wherein said medical risk database further includes information concerning the risk of at least one of the following: incorrect or delayed diagnosis; or missed, incorrect or delayed treatment.

11. The computerized risk management system of claim 9 further including means to provide the health care professional with relevant medical care information concerning the illnesses, diseases or injuries to reduce the possibility of the health care professional missing at least one diagnosis regarding the illnesses, diseases or injuries.

12. A computerized medical chart system for improving the medical care of patients by communicating with a healthcare professional preparing a medical record in connection with recording diagnosis, symptoms, treatment or other patient information, comprising:
a medical risk database containing medical care information regarding the treatment and diagnosis of a plurality of illnesses, diseases and/or injuries, wherein the information contained in the database comprises at least factors regarding increased risk of missed diagnoses that should be addressed in connection with the proper diagnosis and treatment of the patients so as to provide an opportunity for the healthcare professional to meet the requisite medical standard of care in treating the patients and provide proper medical treatment relating to said factors;
means for comparing the recorded symptoms or other patient information with the information stored in the medical risk database to determine compliance with the current medical standard of care with respect to an increased risk of a missed diagnosis as to one or more of the plurality of illnesses, diseases or injuries and whether any additional action should be taken by the health care professional in order to comply with the current medical standard of care; and
means for prompting said healthcare professional to take additional action and include important items of the diagnosis, symptoms, treatment or other patient information in said medical record to maintain a record of said healthcare professional's compliance with said current medical standard of care.

13. The computerized medical chart system of claim 12 wherein said medical risk database further includes information concerning the risk of at least one of the following: incorrect or delayed diagnosis; or missed, incorrect or delayed treatment.

14. The computerized medical chart system of claim 12 further comprising means for prompting a health care professional to take additional action or record additional symptoms or other patient information relevant to complying with said current medical standard of care.

15. The computerized medical chart system of claim 12 further comprising means for associating said recorded symptoms or other patient information with relevant medical care information from said medical risk database regarding compliance with the current medical standard of care.

16. The computerized medical chart system of claim 12 further comprising warning means notifying the health care professional whether important factors leading to the diagnosis with respect to the medical condition of the patient have been documented.

17. The computerized medical chart system of claim 16 wherein said warning means comprises at least one indicator signifying to the health care professional that the important factors have been documented with respect to the medical condition of the patient.

18. The computerized medical chart system of claim 16 wherein said warning means comprises at least one light signifying to the health care professional that the important factors have been documented with respect to the medical condition of the patient.

19. The computerized medical chart system of claim 12 wherein said warning means comprises at least one light signifying to the health care professional that the important factors have not been fully documented with respect to the medical condition of the patient.

20. A computerized medical chart system for communicating with an individual preparing a medical record in connection with preparing or recording diagnosis, symptoms, treatment or other patient information, and including important elements of the patient's medical condition, comprising:
a collection of medical risk information containing medical care information regarding a plurality of illnesses, diseases and/or injuries, and further at least containing information regarding increased risks of missed diagnoses;
means for recording the symptoms or other patient information;
means for comparing the recorded symptoms or other patient information with the medical care information stored in the collection of medical risk information to determine the existence of at least one increased risk of a missed diagnosis based on the symptoms recorded; and,
means for prompting the individual to take particular actions or record additional important items of said diagnosis, symptoms, treatment or other patient information in said medical record, so as to provide the individual with an opportunity to avoid a missed diagnosis and adequately record the action taken.

21. The computerized medical chart system of claim 20 wherein said collection of medical risk information further includes information concerning the risk of at least one of the following: incorrect or delayed diagnosis; or missed, incorrect or delayed treatment.

22. The computerized medical chart system of claim 20 further comprising warning means notifying the individual whether important factors with respect to the medical condition of the patient have been documented.

23. The computerized medical chart system of claim 22 wherein said warning means comprises at least one indicator signifying to the individual that the important factors have been documented with respect to the medical condition of the patient.

24. The computerized medical chart system of claim 23 wherein said warning means comprises at least one light signifying to the individual that the important factors have been documented with respect to the medical condition of the patient.

25. The computerized medical chart system of claim 23 wherein said warning means comprises at least one light signifying to the individual that the important factors have not been fully documented with respect to the medical condition of the patient.

26. A computerized medical chart system for communicating with an individual preparing a medical record in connection with recording signs, symptoms, physical examinations and other patient information leading to the diagnosis and treatment, and including important elements of the patient's medical condition, comprising:
a collection of medical risk information containing medical care information regarding a plurality of illnesses, diseases and/or injuries, and further at least containing information regarding increased risks of missed diagnoses;
means for recording the signs, symptoms, physical examination or other patient information;
means for comparing the recorded symptoms or other patient information with the medical care information stored in the collection of medical risk information to determine the existence of at least one increased risk of a missed diagnosis based on the symptoms recorded; and,
means for prompting the individual to record at least one element of the patient medical condition in said medical record, so as to provide the individual with an opportunity to adequately document the patient medical condition.

27. The computerized medical chart system of claim 26 further comprising warning means notifying the individual whether important factors with respect to the medical condition of the patient have been documented.

28. The computerized medical chart system of claim 27 wherein said warning means comprises at least one indicator signifying to the individual that the important factors have been documented with respect to the medical condition of the patient.

29. The computerized medical chart system of claim 28 wherein said warning means comprises at least one light signifying to the individual that the important factors have been documented with respect to the medical condition of the patient.

30. The computerized medical chart system of claim 28 wherein said warning means comprises at least one light signifying to the individual that the important factors have not been fully documented with respect to the medical condition of the patient.

31. A computerized medical chart system for improving the medical care of patients by communicating with a health care professional preparing a medical record in connection with preparing or recording signs, symptoms, treatment, physical examination or other patient information, and including important elements of the patient's medical condition, comprising:
a medical risk database containing medical care information regarding a plurality of illnesses, diseases and/or injuries, and further at least containing information regarding increased risks of missed diagnoses;
means for providing the health care professional with relevant medical care information so as to reduce the risk of the health care professional missing at least one diagnosis from the plurality of illnesses, diseases, or injuries based on the signs, symptoms, physical examinations or other information regarding the patient leading to the diagnosis and treatment; and,
means for prompting the health care professional to take particular actions or record additional important items of said signs, symptoms, physical examinations, treatment or other information regarding the patient leading to the diagnosis and treatment in said medical record, so as to provide the health care professional with an opportunity to avoid a missed diagnosis and to adequately record the action taken.

32. The computerized medical chart system of claim 31 further comprising means for prompting the health care professional to record symptoms or other patient information relevant to said increased risks.

33. The computerized medical chart system of claim 31 further comprising means for comparing the recorded symptoms or other patient information with the medical care information stored in the medical risk database to determine the existence of at least one increased risk of a missed diagnosis based on the symptoms recorded.

34. The computerized medical chart system of claim 31 further comprising means for associating said recorded symptoms or other patient information with the relevant medical care information related to the increased risk of missed diagnoses with respect to the recorded symptoms or patient information.

35. The computerized medical chart system of claim 31 wherein said collection of medical risk information further includes information concerning the risk of at least one of the following: incorrect or delayed diagnosis; or missed, incorrect or delayed treatment.

36. The computerized medical chart system of claim 31 further comprising warning means notifying the medical care professional whether important factors with respect to the medical condition of the patient have been documented.

37. The computerized medical chart system of claim 36 wherein said warning means comprises at least one indicator signifying to the medical care professional that the important factors have been documented with respect to the medical condition of the patient.

38. The computerized medical chart system of claim 37 wherein said warning means comprises at least one light signifying to the medical care information that the important factors have been documented with respect to the medical condition of the patient.

39. The computerized medical chart system of claim 37 wherein said warning means comprises at least one light signifying to the medical care information that the important factors have not been fully documented with respect to the medical condition of the patient.

40. A computerized medical chart system for communicating with a healthcare professional comprising:
Input means for inputting information regarding a patient;
Data storage means operably connected to the input means for receiving the patient information;
A collection of medical information comprising at least one of the following: risk, healthcare quality or patient safety information;
Means for comparing being operably associated with the data storage means and having access to said collection of medical risk information for comparing said patient information to the medical risk information; and,
Warning means operably associated with said comparing means for issuing one or more of the following: a warning to the healthcare professional when certain conditions arise; or, an alert to the healthcare professional regarding at least one recommendation.

41. The system of claim 40 wherein said system further includes:
Said patient information comprising the vital signs information of the patient;
Display means operably associated with the data storage means for displaying the vital signs information of the patient in graph form so as to show any trends in said vital signs over time;
Said collection of medical risk information including information regarding vital signs trends and normal ranges for such vital signs trends over time; and,
Said warning means issuing a warning when said vital signs trends are outside the normal range.

42. The system of claim 40 wherein said system further includes:
Said patient information comprising the pulse rate and temperature information of the patient;
Said collection of medical risk information including information regarding normal ranges for such patient pulse rates, temperatures and the normal disparity between the two readings; and,
Said warning means issuing a warning when said disparity between pulse rate and temperature is outside the normal range.

43. The system of claim 40 wherein the patient information and the medical risk information further includes the blood pressure and respiratory rate information of the patient.

44. The system of claim 40 wherein said system further includes:
Said collection of medical risk information including information regarding critical events for the patient;
Said means for comparing for determining if there is a critical event occurring regarding the patient; and,
Said warning means issuing a warning when a critical event with respect to the patient is occurring.

45. The system of claim 40 wherein said system further includes:
Said collection of medical risk information including information regarding possible seconds to minutes emergency situations that occur with respect to patients;
Said means for comparing determines if there is a seconds to minutes emergency occurring; and,
Said warning means issuing a warning when a seconds to minutes emergency is occurring.

46. The system of claim 40 wherein said system further includes:
Said collection of medical risk information including information regarding increased risk situations;
Said means for comparing determines if there is an increased risk situation; and,
Said warning means provides a risk alert to the healthcare provider when an increased risk situation occurs; and,
Means to provide information about the increased risk situation to the healthcare provider.

47. The system of claim 40 wherein said system further includes:
Said collection of medical risk information including information regarding evidence based treatment information;
Said means for comparing determines if the evidence based treatment information is applicable to the patient; and,
Means to provide a treatment recommendation to the healthcare provider when said evidence based treatment information is applicable.

48. The system of claim 47 further including:
Said collection of medical risk information further including patient management information; and,
Wherein said means to provide a treatment recommendation further includes providing a management recommendation to the healthcare provider when applicable.

49. The system of claim 40 wherein said system further includes:
Said collection of medical risk information including information regarding patient attributes;
Said comparing means providing information choices to the healthcare provider based on the patient information; and,
Said comparing means comparing said patient attributes to said information in said medical risk information and filtering the information choices presented to the healthcare provider as dynamic content depending on the patient attributes.

50. The system of claim 40 further including:
A rules engine providing information regarding the patient to the healthcare provider in response to the presence of certain conditions based on the patient information.

51. The system of claim 50 wherein the information provided is a request for the input of additional patient information.

52. The system of claim 50 wherein the information provided is a recommendation to take action, if certain conditions are met by the patient information that has been provided.

53. The system of claim 40 wherein said system further includes:
Said collection of medical risk information including information regarding differential diagnosis information regarding certain symptoms;
Said means for comparing determines if the differential information is applicable to the patient; and,
Means to provide information to the healthcare provider interactively about the differential diagnosis in real time when said information is applicable.

54. A method for alerting a healthcare professional to patient information comprising:
Inputting patient information into data storage means operably connected thereto;
Comparing such patient information to information contained in a collection of medical information including at least one of the following: risk; healthcare quality; or, patient safety information, operably accessible thereto; and,
Warning the healthcare professional when certain conditions arise.

55. The method of claim 54 further including;
The patient information comprising the vital signs information of a patient over time;
Displaying the vital signs of the patient in graph form on display means operably associated with the data storage means to show any trends therein;
The medical risk information comprising normal ranges for vital signs trends; and,
Said warning occurring when said vital signs trends are outside the normal ranges.

56. The method of claim 54 further including:
The patient information comprising one or more of the following: the pulse rate;
blood pressure; respiratory rate; and, temperature information of the patient;
The medical risk information comprising normal ranges for the disparity between two or more of the following: the pulse rate; blood pressure; respiratory rate; and, temperature information for the patient; and,
Said warning occurring when said disparity between two or more of the following: the patient pulse rate; blood pressure; respiratory rate; and temperature, are outside the normal ranges.

57. The method of claim 54 further including:
The medical risk information comprising critical events for the patient; and,
Said warning occurring when a critical event regarding the patient occurs.

58. The method of claim 54 further including:
The medical risk information comprising increased risk situations; and,
Said warning occurring when an increased risk situation occurs.

59. The method of claim 54 further including:
The medical risk information comprising possible seconds to minutes emergencies that occur with patients; and,
Said warning occurring when a seconds to minutes emergency situation exists with respect to the patient.

60. The method of claim 54 further including:
The medical risk information comprising evidence based treatment and management information; and,
Providing a treatment and management recommendation to the healthcare provider when evidence based treatment is applicable with respect to the patient.

61. The method of claim 54 further including:
The medical risk information comprising the particular attributes of the patient;
Filtering the information choices provided to the healthcare provider based on the patient attributes; and,
Providing information choices as dynamic content to the healthcare provider.

62. The method of claim 54 further including:
Providing information regarding the patient to the healthcare provider based on a rules engine.

63. The method of claim 54 further including:
The medical risk information comprising information regarding differential diagnosis information regarding certain symptoms; and,
Providing differential diagnosis information to the healthcare practitioner interactively in real time when applicable.

64. The computerized medical chart system of claim 40 wherein said medical risk database further includes information concerning patient safety.

65. The computerized medical chart system of claim 40 wherein said medical risk database further includes information concerning the risk of at least one of the following: incorrect or delayed diagnosis; or missed, incorrect or delayed treatment.
